(19) United States
(12) Patent Application Publication
(10) Pub. No.: US 2021/0362758 A1
(43) Pub. Date: Nov. 25, 2021

(54) RETENTION AND LOADING AND UNLOADING IN HIGH SPEED TRANSPORTATION SYSTEMS

(71) Applicant: Hyperloop Technology Engineering Limited, Blackburn (GB)

(72) Inventors: Brogan Garrett Bambrogan, Los Angeles, CA (US); Nima Bahrami, Palos Verdes Estates, CA (US); Ryan Matthew Kraft, Hermosa Beach, CA (US); Quentin M. D'Avout, Long Beach, CA (US); David Alexander Browne, Los Angeles, CA (US); James Robert Dorris, III, Solana Beach, CA (US); Tyler Atkinson Jacobs, Redondo Beach, CA (US); Chi Cheung, New York, NY (US); Chad Albert Baker, Brea, CA (US)

(21) Appl. No.: 16/763,908

(22) PCT Filed: Nov. 13, 2018
(86) PCT No.: PCT/US2018/060862

§ 371 Date: May 13, 2020

Related U.S. Application Data
(60) Provisional application No. 62/638,777, filed on Mar. 5, 2018.
(60) Provisional application No. 62/585,610, filed on Nov. 14, 2017.

(51) Int. Cl. B61L 27/00; B60L 13/06

(52) U.S. Cl. CPC B61L 27/0027; B60L 9/16; B61L 27/0077; B60L 13/06

(57) ABSTRACT

Techniques for injecting a vehicle into a high speed transportation system are described. A travel request is received from a user. The user is determined to be authorized to travel using the high speed transportation system, based on a profile associated with the user. An injection portal for the user to enter the transportation system is identified. One or more instructions for the user are provided, relating to the injection portal. A vehicle associated with the user is identified at the injection portal. Characteristics of the vehicle are sensed at the injection portal, including a center of gravity of the vehicle. The characteristics are determined to satisfy threshold values, and the vehicle is authorized for travel in the transportation system. A vehicle profile is generated. The vehicle profile is transmitted to a second controller associated with the transportation system. The vehicle is injected into the transportation system.

### CROSS-REFERENCE TO RELATED APPLICATIONS

This application claims benefit to U.S. provisional application Ser. No. 62/585,610 filed on Nov. 14, 2017 and to U.S. provisional application Ser. No. 62/638,777 filed on Mar. 5, 2018. The aforementioned related patent applications are herein incorporated by reference in their entirety.

### TECHNICAL FIELD

Aspects of the present disclosure relate to high speed transportation systems, and more specifically, though not exclusively, to techniques for quickly and efficiently checking, verifying and preparing a vehicle, its cargo, and associated control systems to transition the vehicle from movement on a traditional road to movement on a dedicated guideway or corridor, in a manner appropriate for high speed, high throughput, highly automated, packetized transportation systems, such as certain hyperloop systems.

### BACKGROUND

A high speed transportation system can include a dedicated guideway or corridor for travel. Users travel through the guideway using specially configured pods, or using vehicles suitable for traditional roads. The user can enter the dedicated guideway through designated entry points, after which the user travels through the high speed transportation system.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates an example high speed transportation system, according to one embodiment described herein.

FIG. 2 illustrates block diagrams for components of a high speed transportation system, according to one embodiment described herein.

FIG. 3 illustrates communication within a high speed transportation system, according to one embodiment described herein.

FIG. 4 illustrates an example vehicle flow, according to one embodiment described herein.

FIG. 5 is a schematic representation of a retention mechanism, according to one embodiment described herein.

FIG. 6 is a schematic representation of a method of retention mechanism operation, according to one embodiment described herein.

FIG. 7 illustrates an example payload's traversal path through a carrier, according to one embodiment described herein.

FIG. 8 illustrates an example retention mechanism placement, according to one embodiment described herein.

FIGS. 9A and 9B are illustrations of example retention mechanism placement relative to the carrier, according to one embodiment described herein.

FIG. 10 illustrates one example of a retention mechanism in an engaged and disengaged mode, according to one embodiment described herein.

FIG. 11 illustrates a further example of a retention mechanism in an engaged and disengaged mode, according to one embodiment described herein.

FIG. 12 illustrates a further example of a retention mechanism pair engaging an attachment feature, according to one embodiment described herein.

FIG. 13 illustrates a further example of a retention mechanism pair engaging and disengaging an attachment feature, according to one embodiment described herein.

FIGS. 14A-14F illustrate further examples of the retention mechanism, according to one embodiment described herein.

FIGS. 15A-15D are examples of retention mechanisms and guidance mechanisms for a carrier, according to one embodiment described herein.

FIG. 16 illustrates an example carrier footprint, according to one embodiment described herein.

FIG. 17 is a flowchart illustrating payload loading and unloading, according to one embodiment described herein.

FIGS. 18A-E illustrate examples of a precheck system, payload, and carrier interaction, according to one embodiment described herein.

FIG. 19 illustrates an example of determining payload parameters, according to one embodiment described herein.

FIG. 20 illustrates an example of payload loading and unloading, according to one embodiment described herein.

FIG. 21 illustrates an example external guidance mechanism, according to one embodiment described herein.

FIG. 22 illustrates example control systems of the transportation system, according to one embodiment described herein.

FIG. 23 is a flowchart illustrating injecting a pod at a portal, according to one embodiment described herein.

FIG. 24 is a flowchart illustrating verifying a pod at a portal, according to one embodiment described herein.

FIG. 25 is a flowchart illustrating sensing incoming pod characteristics, according to one embodiment described herein.

FIG. 26 is a flowchart further illustrating loading a payload onto a carrier, according to one embodiment described herein.

### DETAILED DESCRIPTION OF EXAMPLE EMBODIMENTS

### Overview

Embodiments described herein include a method for injecting a vehicle into a transportation system. The method includes receiving a travel request from a user for the transportation system. The method further includes determining that the user is authorized to travel using the transportation system, based on a profile associated with the user. The method further includes identifying an injection portal for the user to enter the transportation system. The method further includes providing one or more instructions for the user relating to the injection portal. The method further includes transmitting a notification to a first controller associated with the injection portal, the notification including identification data related to the user. The method further includes identifying, at the injection portal, a vehicle associated with the user, based on the identification data. The method further includes sensing a plurality of characteristics of the vehicle at the injection portal, the plurality of characteristics including a center of gravity of the vehicle. The method further includes determining that the plurality of characteristics satisfy one or more corresponding threshold values, and based on this determination authorizing the vehicle for travel in the transportation system. The method further includes generating a vehicle profile related to the vehicle. The method further includes transmitting, using a communication network, the vehicle profile to a second controller associated with the transportation system. The method further includes injecting the vehicle into the transportation system, at the injection portal.

Embodiments described herein further include a method for injecting a vehicle into a transportation system. The method further includes identifying an injection portal for a user to enter the transportation system. The method further includes identifying, at the injection portal, a vehicle associated with the user. The method further includes sensing a plurality of characteristics of the vehicle at the injection portal. The method further includes determining that the plurality of characteristics satisfy one or more corresponding threshold values and, based on this determination authorizing the vehicle for travel in the transportation system. The method further includes injecting the vehicle into the transportation system, at the injection portal.

Embodiments described herein further include a method for injecting a vehicle into a transportation system. The method includes identifying, at an injection portal associated with the transportation system, a vehicle associated with a user. The method further includes sensing a plurality of characteristics of the vehicle at the injection portal, the plurality of characteristics including a center of gravity of the vehicle. The method further includes determining that the plurality of characteristics satisfy one or more corresponding threshold values, and based on this determination authorizing the vehicle for travel in the transportation system. The method further includes injecting the vehicle into the transportation system, at the injection portal.

### EXAMPLE EMBODIMENTS

Aspects of the present disclosure relate to a high speed, high throughput, highly automated, packetized transportation system. The transportation system functions to transport pods between geographic locations along interconnected guideways. In one example, the transportation system includes carrier pods suitable for transporting a payload through the transportation system. In this example, the transportation system can include a pod that is configured to carry a user's street vehicle through the high speed transportation system. As discussed in one or more embodiments below, in one example a user can drive his or her vehicle to an injection portal. In this example, the portal can verify that the user's vehicle is suitable for transport, and, if so, the user can secure his or her vehicle to a carrier, and the carrier can be injected into the high speed transportation system. Similarly, the carrier could be configured to carry freight or other cargo through the high speed transportation system.

In another example, a user can travel to the injection portal using a vehicle configured for both travel on traditional roads and in the guideway. In this example, the user can travel from his or her origin (e.g., his or her home) to an injection portal, using this vehicle. Upon reaching the injection portal, the portal can verify that the vehicle is suitable for transport, and inject the vehicle into the high speed transportation system.

In a further example, a user can travel to an injection portal using a traditional form of transportation (e.g., his or her home vehicle, a mass transit system, etc.). At the injection portal, the user can enter a pod, and the pod can be injected into the high speed transportation system. Similarly, freight or other cargo can be carried to an injection portal (e.g., using a traditional form of transport or a specially configured pod), and the freight or cargo can be carried in a pod and injected into the high speed transportation system.

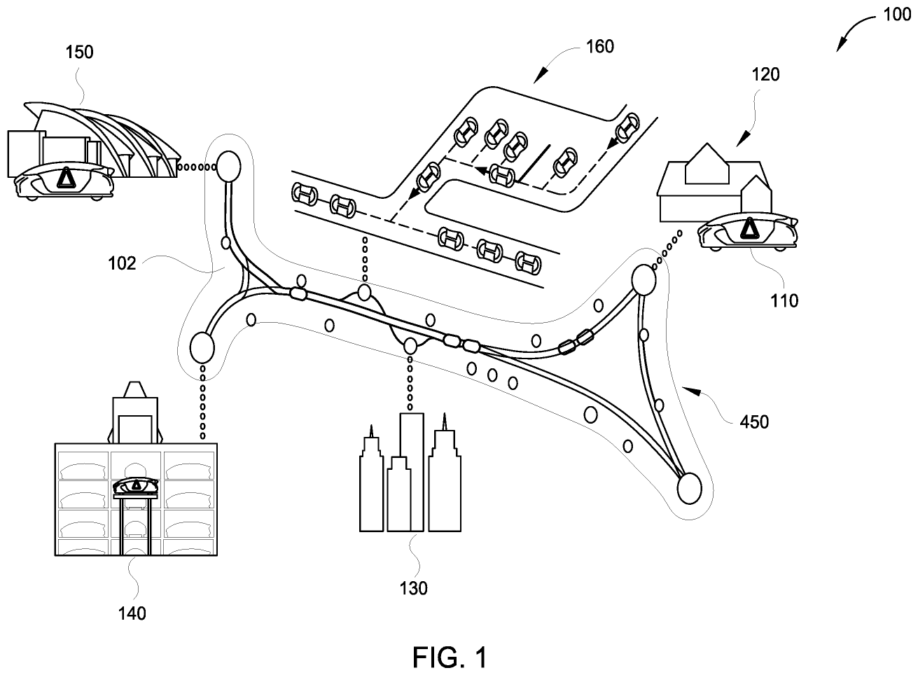

FIG. 1 is an example illustration of a high speed transportation system 100. A pod 110 travels on a guideway 102. In one embodiment, the guideway 102 is a fixed track, or path, suitable to carry pods. In other embodiments, the guideway 102 could be changeable to accommodate differing traffic patterns or transportation needs. As used herein the guideway 102 can refer to multiple interconnected guideways, multiple disconnected guideways, a single guideway, or any suitable number of guideways. In an embodiment, as discussed further below, the guideway 102 can provide automated or semi-automated travel to the user. For example, sensors on or near the guideway 102 can detect the user's vehicle's position and provide for automated travel. In an embodiment, the guideway 102 can provide automated or semi-automated propulsion to the pod. For example, the guideway 102 can control the propulsion and levitation (if applicable) of the pod.

In one embodiment, pods within the high speed transportation system 100 are fully automated. In other embodiments, pods within the high speed transportation system 100 can be largely automated, with some limited control by a passenger. The guideway 102 provides high speed transportation between many different points, including a residence 120, an urban area 130, and an airport 150. Further, the guideway 102 can provide transportation to an inventory center 140, at which the pods 110 can be stored when not in use.

In an embodiment, the inventory center 140 can include maintenance facilities. Maintenance facilities maintain the pods. In an embodiment, the pods are dynamically routed to the maintenance facilities in response to pod problem detection or prediction. In an embodiment, the maintenance facilities are automated and include a maintenance facility control system that can function to: repair pod problems, communicate with pods, communicate with a central control system to coordinate pod arrival, storage, and departure, and to receive/report pod problem status.

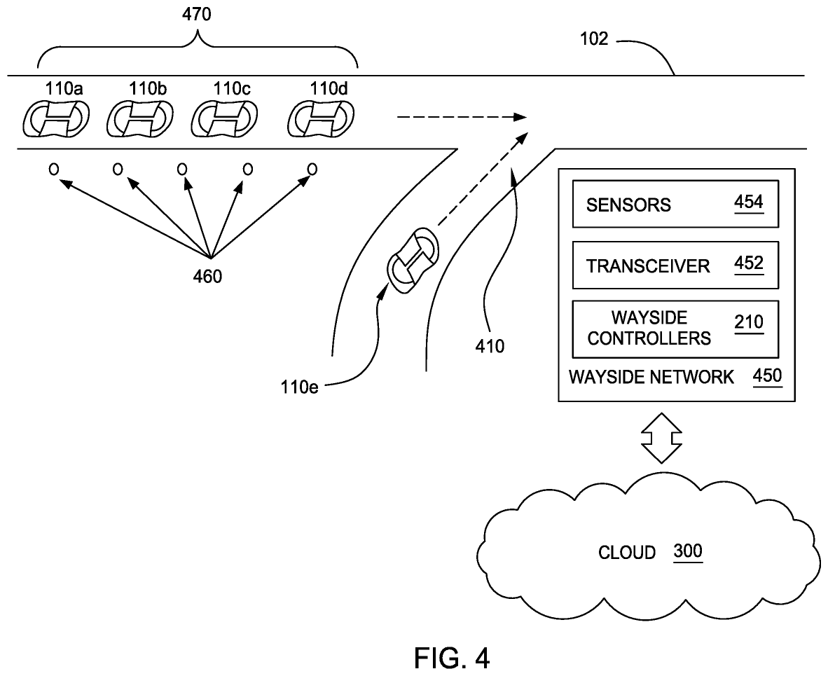

Further, the guideway 102 can provide transportation to a parking center, at which pods carrying users' vehicles (e.g. users' cars) can unload empty user vehicles for parking (or load user vehicles onto empty carrier pods), preferably automatically. The guideway 102 further includes numerous wayside structures for managing travel, including wayside 450. The wayside 450 is discussed in more detail with regard to FIG. 4.

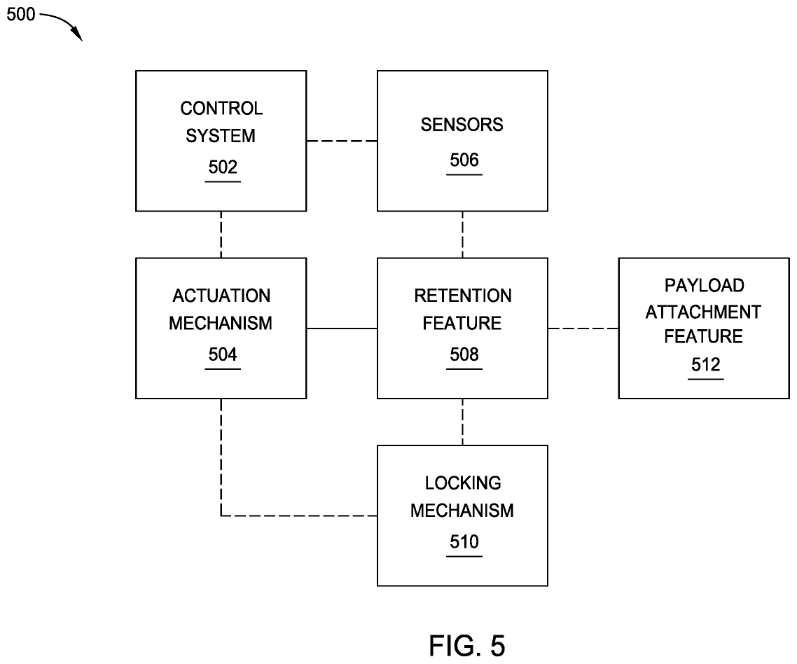

The pods 110 can come in many different configurations. In one configuration, a pod 110 removably attaches to a user's vehicle and carries the user's vehicle through the guideway 102. For example, a pod 110 can be a carrier for a payload (e.g., a user's vehicle), as discussed with regard to FIG. 5 and after, below.

In another configuration, a pod 110 can be configured to hold a pallet or load of freight, which the pod 110 can transport through the guideway 102. In another configuration a pod 110 can be configured to hold several individual passengers and can transport these passengers through the guideway 102. In an embodiment, each of these passengers would opt to or be pre-selected as heading to the same destination, allowing for packetized transportation of those passengers from their origin to their desired destination without interruption or intermediate stops. In another configuration, a pod 110 can be configured to act as a door-to-door vehicle, capable of traveling along ordinary roadways and traveling through the guideway 102. These are merely examples of possible configurations for a pod 110. The embodiments herein are not limited to these examples and can be used with any suitable configuration of a pod 110.

A user of the system can request travel from a particular origin to a particular destination. The user can also specify additional preferences or requirements, including travel beginning at a specific time, travel arriving at the destination at a particular time, travel tied to a particular event (e.g., so that the user arrives at an airport before a flight departs, or at an event before the event begins). Further, a user can request expedited travel (e.g., a user could pay more for expedited loading at portals, or for shorter more direct routes, or for immediate or quicker injection into the guideway), can allow (or bar) travel with other users, etc.

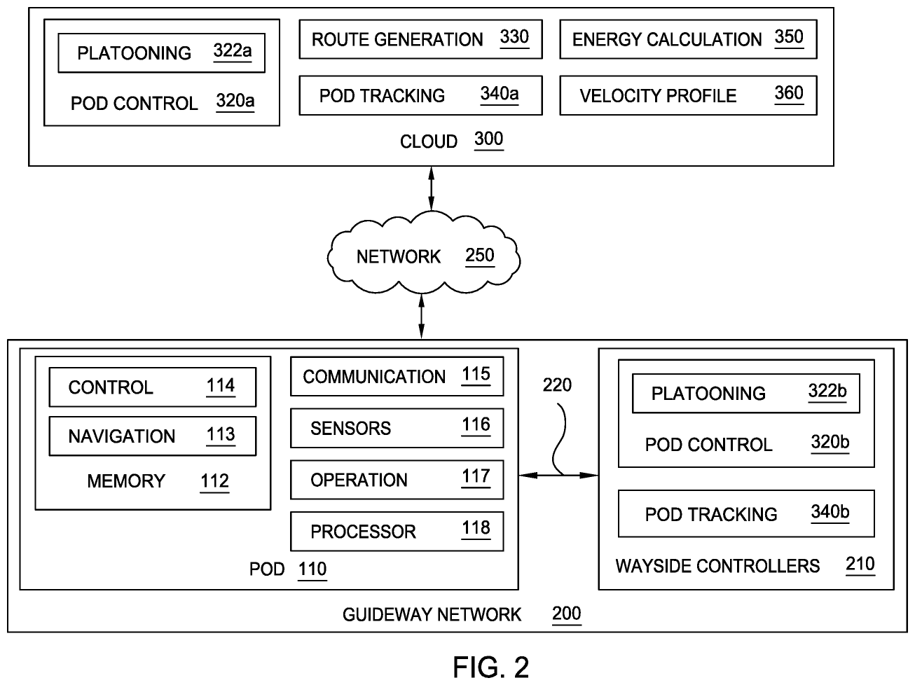

As an example, a user drives his or her ordinary vehicle (e.g. car) from a residence 120 to a portal 160 to the guideway 102. The user requested travel from the portal 160 (or from the cloud, e.g. via a client app) to a particular destination. This request is transmitted to a suitable computer server (e.g., within the cloud 300 or the wayside controller 210 illustrated in FIG. 2). Upon reaching the portal 160, the user's vehicle (with the user inside) is automatically or semi-automatically attached to/retained by a carrier pod 110, or is rejected. In an embodiment, the pod 110, portal 160, or guideway 102 determine the mass and structural configuration and other parameters of the user's vehicle and determine whether the user's vehicle is suitable for attachment to a pod 110. Upon determination that the user's vehicle is suitable, the vehicle is retained by the pod 110. Upon determination that the user's vehicle is unsuitable, the vehicle is rejected for retention/attachment by the carrier pod, or if it has already been retained then the vehicle is released or the pod (with vehicle) are moved to a holding area where the issue causing the rejection may be addressed. Alternatively, the user may walk to a portal 160 and enter a pod 110, without use of an ordinary user vehicle. Pods that retain and carry user vehicles (e.g. cars) may be configured differently from pods that carry solely users or pods that carry cargo.

Alternatively, pods may be configured to operate on both ordinary surface roads and the dedicated guideways and corridors. As an example, a user drives his or her pod from a residence 120 to a portal 160 to the guideway 102. The user requested travel from the portal 160 (or from the cloud, e.g. via a client app) to a particular destination. This request is transmitted to a suitable computer server (e.g., within the cloud 300 or the wayside controller 210 illustrated in FIG. 2). Upon approaching or reaching the portal 160, the pod 110, portal 160, or guideway 102 determine the mass and structural configuration and other parameters of the user's pod and determine whether the user's pod is suitable for injection onto the main guideway. Upon determination that the user's pod is suitable, the pod is injected onto the main guideway. Upon determination that the user's pod is unsuitable, the pod is rejected for injection, or if it has already been injected onto a guideway section that is not the main guideway (e.g. an onramp guideway or a evaluation guideway), then the pod is directed back onto a surface road, or is directed to a holding area where the issue causing the rejection may be addressed.

A user request for travel may be inferred, e.g. the cloud 300 may have access, to the user's schedule, directly (e.g. through an API to the user's phone and calendar) or indirectly, based on historical data (e.g. normal commuting patterns), third party data (holiday schedule, flight departure information), and/or any other suitable technique.

The pod 110 is injected into the guideway 102. The portal 160 is representative of a single portal, or multiple portals. After being injected into the guideway 102, the user travels along the guideway 102 in their normal vehicle attached to a pod 110, until reaching a destination (like the airport 150 or the urban area 130). Alternatively, as discussed above, a pod 110 could be configured to travel on both ordinary roads and the guideway 102, and could pick up the user at his or her residence 120. The pod 110 could then transport the user to a portal 160 at the guideway 102, where the pod 110 could be injected into the guideway 102 and travel to the user's destination. Or, as another alternative, the user could transport him or herself from their residence 120 to a portal 160 for the guideway 102. The user could park near the entry point and walk in to a pod 110 configured to carry one or multiple users to their destinations.

FIG. 2 is an illustration of block diagrams for certain components of a high speed transportation system 100. The pod 110 serves to transport a payload (e.g., passengers, normal vehicles, or freight) through the high speed transportation system 100. The pod 110 is associated with a set of pod characteristics, which can be stored on-board the pod 110, stored in the cloud 300 or wayside controller 210, measured ad hoc, or can be otherwise determined. The pod characteristics can include: the mass and/or mass distribution (e.g., loaded, unloaded), priority (e.g., the priority of the payload contained therein, such as organs or tissues, pod class, such as emergency or cargo, etc.), pod acceleration limits (e.g., specific to the pod or pod type, determined from the payload acceleration limits, etc.), a pod two or three dimensional nominal profile, suspension or dampening characteristics, or any other suitable characteristic.

The pod 110 can be associated with a pod identifier, which functions to globally or locally identify the pod 110. The pod identifier can be used to determine pod operation parameters, used as an address for packets for the pod, or otherwise used. The pod identifier can be: optical (e.g., barcode, QC code), wireless (e.g., RFID, MAC address, Bluetooth identifier, etc.), a characteristic pattern (e.g., a unique vibration pattern as the pod passes along a guideway), or be any other suitable identifier.

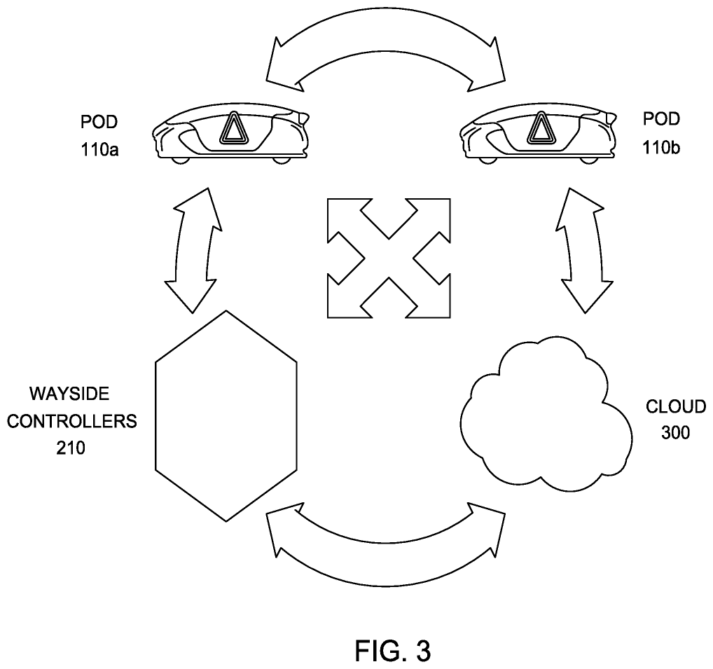

The pod 110 includes a communication module 115. Communication module 115 facilitates communication with the guideway 102, other pods 110, the wayside controllers 210, and the cloud 300. This is described in more detail with regard to FIGS. 3 and 4. The communication module 115 can include all equipment necessary to facilitate both short-distance communication and longer distance communication, including one or more antennas, one or more transceivers, and associated controllers and software modules. The communication module 115 can also be used to communicate with a communication network 250. The communication network 250 can be any suitable communication network, including the Internet, a local access network, a mesh network, or a wide access network. The communication module 115 can use any suitable communication protocol, including any suitable wireless protocol. For example, the communication module 115 can use an IEEE Wi-Fi standard, like an 802.11 standard (e.g., IEEE 802.11p). The 802.11p standard is one option for communication by vehicles, like the pod 110, but any suitable communication protocol can be used, including various Wi-Fi standards, cellular protocols (including 3G, LTE, 4G and others), and Bluetooth.

The pod 110 further includes one or more sensors 116. The sensors 116 are used to sense properties associated with travel by the pod 110 on a guideway (like guideway 102 illustrated in FIG. 1) or on an ordinary road. For example, sensors 116 can sense the location, velocity, acceleration, and orientation of the pod 110, along with any other relevant properties. The sensors 116 can also include visual and audio sensors to facilitate automated operation of the pod 110, including cameras, infra-red sensors, radio sensors, and the like. Further, the sensors 116 can sense the mass of the pod, including any passengers or cargo, and can sense various aerodynamic properties related to the pod 110. For example, if the propulsion system for the guideway 102 and pods 110 uses magnetic levitation, the pod 110 can sense the mass of the pod through electromagnetic characteristics related to levitation. As another example, the pod 110 could calculate its mass based on other characteristics of the pod, such as comparing the force being applied to or by the pod 110 against the acceleration of the pod 110. The sensors 116 can also sense properties associated with route planning, including travel duration, air temperature, etc. And the sensors 116 can sense properties associated with other pods 110 on the guideway or road, e.g. via LIDAR or laser, including the distance to other pods 110. The sensors may further sense and communicate with track beacons placed on or along the guideway.

The pod 110 also includes one or more operation components 117, related to operation of the pod. The operation components 117 can include components for causing the pod to accelerate or brake, levitate, and components related to steering. In one embodiment, the guideway 102 provides motive power for the pod 110. This could be done, for example, through an electromagnetic propulsion system in which the active components of a linear motor are located in the guideway 102 and are used to propel the pod 110 along the guideway. In an embodiment, the operation components 117 within the pod 110 could also include a motor and a battery to facilitate emergency propulsion in case the primary propulsion system fails, or to provide propulsion when the pod is traveling off the guideway on roads.

In another embodiment, motive power could be provided by a combination of motors in the guideway 102 and the pod 110. Primary motive power could be supplied by the guideway 102, with the pod 110 providing supplemental motive power to, for example, accelerate within the guideway 102, enter the guideway 102, and exit the guideway 102. For example, the guideway 102 could include a number of wayside motors powered by the electrical grid and used for primary propulsion, while each pod 110 could include a battery and a vehicle motor within its operation components 117, for supplemental propulsion and/or additional control (e.g. for relative motion between pods). In another embodiment, motive power could be supplied solely by the pod 110 itself. The pod 110 could use any suitable propulsion system, including a linear induction motor, linear synchronous motor, internal combustion engine, hybrid engine, and the like. The pod can have multiple propulsion/levitation systems, e.g. a pod can have both a combustion engine (driving retractable wheels) and a electromagnetic motor (with coils and/or permanent magnets). Alternatively, the pod may have only one system, e.g. only battery powered rotary motors powering wheels that operate on both surface roads and dedicated guideways.

A pod 110 includes one or more computer processors 118. The processor 118 generally retrieves and executes programming instructions stored in the memory 112. The processor 118 is included to be representative of a single central processing unit (CPU), multiple CPUs, a single CPU having multiple processing cores, graphics processing units (GPUs) having multiple execution paths, and the like. The memory 112 is generally included to be representative of electronic storage of any suitable type(s), including random access memory or non-volatile storage.

The memory 112 generally includes program code for performing various functions related to the pod 110. The program code is generally described as various functional “applications,” “components,” or “modules” within the memory 112, although alternate implementations may have different functions and/or combinations of functions. Within the memory 112, the control module 114 is generally configured to control the pod 110. For example, the control module 114 controls operation components 117, communication module 115 and sensors 116.

The navigation module 113 is controls navigation of the pod 110. The navigation module 113 could, for example, receive information from a GPS receiver about the location of the pod. Or the navigation module 113 could, for example, receive information from navigation beacons located on guideway 102. The navigation module 113 could further receive navigation instructions from a module within the wayside controllers 210 or cloud 300. These instructions could be used to control navigation through the guideway 102 or through an ordinary road.

The modules illustrated in FIG. 2 for the pod 110 are merely illustrative examples, and are not intended to be limiting. The pod 110 could include numerous other modules. For example, the pod 110 could include one or more visual display devices, like video display screens. The pod 110 could further include one or more audio sensors, like microphones, and one or more audio output devices, like speakers. The pod 110 can also include one or more GPS receivers and transmitters.

The cloud 300 illustrated in FIG. 2 represents a cloud computing infrastructure. Cloud computing generally refers to the provision of scalable computing resources over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. The cloud 300 can be made up of any number of physical servers with processors, memory, etc. Servers within the cloud 300 can communicate with the network 250. The servers will generally be remotely located from the components of FIG. 1. The communication network 250 can be any suitable communication network, including the Internet, a local access network, a mesh network, or a wide access network. The network may be wired or wireless or both.

The cloud 300 generally includes program code for performing various functions related to the high speed transportation system 100. The program code is generally described as various functional “applications,” “components,” or “modules” within the cloud 300, although alternate implementations may have different functions and/or combinations of functions. The cloud 300 can include numerous modules related to the high speed transportation system 100. As one example, the cloud 300 includes a route generation module 330 to be used to generate routes for the various pods 110 within the high speed transportation system 100.

Generation of routes can include: receiving the route; selecting the route (e.g., based on a score, collision probability, etc.); calculating the route; optimizing the route for a cost function or set of system variables, minimizing a set of system variable values; searching a graph representing the transport network; performing a topology based search of search space; static routing; dynamic routing; selecting a predetermined route template; using distance vector routing protocols, link-state routing protocols, optimized link state routing protocols, path vector protocols, or using any other suitable pathing method. The route can be determined for a single agent (e.g., the pod), multiple agents (e.g., multiple static pods; multiple en-route pods; both static and en-route pods; etc.), or for any suitable number of agents. The route can be determined based on current, historic, and/or anticipated: payload parameters, route variables (e.g., pod density, energy consumption, number of pod entries or exits, etc.), routes for other pod, or pod operation parameters; or any other suitable parameter.

The route can be optimized for: time efficiency, overall energy consumption, load balancing for a route segment, load balancing across a transport network, route duration, average pod speed, cost, transition points (e.g., number of transitions), waypoints to avoid, waypoints to encounter, fleet formation creation, or any other suitable system variable (e.g., path criteria). The system variables can be weighted or unweighted. The weight can be static, dynamically determined based on the current or anticipated network parameters (e.g., load, number of collisions, etc.), the pod priorities, or otherwise determined. An entire route (e.g., end-to-end route) is preferably determined for each pod. Alternatively, partial routes (e.g., route segment up to the next transition point) can be determined, which can enable faster computation and/or dynamic response to route changes (e.g., due to unexpected segment loading, collision detection, etc.). Alternatively, an entire route can be determined for a pod, but only a predetermined number of segments are transmitted to the pod. However, any suitable route portion can be determined or provided to the pod.

In a first variation, the route is received from a user, wherein the route can be specified by waypoints, a set of guideway segment selections, or otherwise specified. In a second variation, the route can be determined by identifying a plurality of potential routes, scoring each route of the plurality (e.g., based on the route segment load, total travel time, etc.), and selecting a route from the plurality based on the score. In a third variation, the route can be determined using a graph search (e.g., using Dijkstra's, A*, D*, Floyd-Warshall, Johnson's, or any other suitable algorithm), wherein the graph represents the transport network. In a fourth variation, the route can be determined using a neural network trained on past routes (e.g., for the pod, the payload class, the start and end location pair, etc.). However, the route can be otherwise determined.

The pod tracking module 340a can be used to track the various pods 110 within the high speed transportation system 100. This can be done using GPS receivers and transmitters on the pods 110, through sensors or beacons located on or near the guideway 102, through seeking or receiving location information from wayside controllers 210, or through any other suitable mechanism. The pod control module 320a is generally configured to control the various pods 110 within the high speed transportation system 100. The pod control module 320a can control the pod 110 through instructions to wayside controllers 210, through instructions to the pod 110, or through instructions to both. In an embodiment, wayside motors generally provide all the propulsive power the pod 110. In this embodiment, the pod control module 320a controls the pod 110 through instructions to the wayside controllers 210. In another embodiment, wayside motors provide some of the propulsive power to the pod and vehicle motors on the pod provide some of the propulsive power. In this embodiment, the pod control module 320a can control the pod 110 through instructions to both the wayside controllers 210 and the pod 110. In another embodiment, the pod itself provides all the propulsive power as it moves through the system (e.g. batteries powering rotary motors driving wheels). In this embodiment, the pod control module 320a can control the pod through instructions to the pod 110, which may be transmitted through and using network 250, guideway network 200, other pods (e.g. through mesh networking) and wayside controllers 210.

The pod control module 320a can provide instructions that result in or cause the pod 110 to accelerate, brake, turn, enter the guideway 102, exit the guideway 102, navigate to a particular point within the guideway 102, etc. As discussed in more detail below, the instructions to control the pod 110 can come solely from the pod control module 320a in the cloud 300, solely from the pod control module 320b in the wayside controllers 210, or from a combination of the pod control module 320a in the cloud 300 and the pod control module 320b in the wayside controllers 210.

The pod control module 320a also includes a platooning module 322a. The platooning module 322a facilitates various features related to platooning the pods 110. In an embodiment, the platooning module 322a, and other modules within the cloud 300, can receive reports from modules within the wayside controllers 210, the guideway 102, the pod 110, and third parties. These reports can provide information about the current status of various items within the system 100, including the location of pods 110 within the guideway 102, the status of various parts of the guideway 102, temperature and weather information, traffic information, etc.

The cloud 300 can further include an energy calculation module 350. The energy calculation module 350 can be used to estimate energy usage by a pod 110, or multiple pods 110, through various routing options. The energy calculation module can also be used to calculate actual energy usage by a pod 110, or multiple pods 110, through the system. The cloud 300 can further include a velocity profile module 360. The velocity profile module 360 can determine or estimate a velocity profile for a pod 110's route, based on the maximum velocity, route shape, maximum acceptable lateral acceleration, congestion, and other factors (retrieved, calculated, predetermined or based on historical records). One other factor may be the characteristics or capabilities of the motor (whether located wayside, or on the pod, or both). For example, the higher the velocity, the less capable a motor may be of generating acceleration. The maximum acceptable lateral acceleration can be relevant to energy usage because it can control how quickly the pod 110 can travel through curves or turns (e.g., slower travel for human comfort might use less energy because slower travel results in less aerodynamic drag, while faster travel might use more energy). The velocity profile module 360 may ordinarily be invoked prior to a pod's injection to generate a profile for an entire route, but may also be called upon to generate a profile for a segment(s) of a route, e.g. an onramp injection portion, or called upon for a pod that is already traveling. While not illustrated in FIG. 2, the wayside controllers 210 can also include an energy calculation module and a velocity profile module, which can be used to supplement (or replace) the energy calculation module 350 and the velocity profile module 360.

The wayside controllers 210 are computing systems located nearby (in distance or in network latency) to the components of the high speed transportation system 100, such as guideways 102, portals 160, and switches. The cloud 300 is made up of servers that may be located at a distance from the high speed transportation system 100 components, which can be distributed across a large geographic area. This can be a physical distance, in miles or kilometers, or a latency distance, in time. The cloud 300, therefore, is normally more suitable for general guidance in the high speed transportation system 100, like route determination, platooning determination, guidance on generally when to inject a pod 110 into the guideway 102, etc. But the cloud 300 may not be suitable for applications that are more time sensitive. Instead, in one embodiment, the high speed transportation system 100 can include the wayside controllers 210. The wayside controllers 210 can be made up of computers located at various sites near or on the guideway 102, including portals, injection sites, merge points, off-ramps, etc. The wayside controllers 210 can be located physically near the guideway 102, and also nearby in terms of network latency, to facilitate rapid communication between the wayside controllers and components in and on the guideway 102. The wayside controllers 210 can also be connected to various sensors along the guideway 102. This is preferably a hardwired connection to further reduce latency and increase reliability, but may also be a wireless connection, or any other suitable connection.

The wayside controllers 210 can act as an intermediate layer between the cloud 300 and the various pods 110. In one embodiment, modules within the wayside controllers 210 receive guidance or desired outcomes from modules within the cloud 300. The modules within the wayside controllers 210 can then use this guidance to implement and achieve the desired outcome. For example, modules within the wayside controllers 210 may then directly control the guideway 102 and/or the pod 110. Or the modules may or generate instructions and commands to convey to the guideway 102 and/or the pod 110. Because the computers making up the wayside controllers 210 are located closer to the guideway 102 and the pods 110 in terms of network latency, the various modules of the wayside controllers 210 can act quickly to handle fast-moving pods. For example, the pod control module 320b can receive information about the position and speed of a pod 110, can compute an appropriate injection point for the pod 110 into the guideway (or other suitable commands, e.g. injection time and injection velocity/acceleration profile), and can execute commands to cause the pod 110 to move and enter the guideway 102 at the desired injection point.

In an embodiment, the pod control module 320a of the cloud 300 provides guidance to the pod control module 320b of the wayside controllers 210. For example, the pod control module 320a can provide general guidance to the pod control module 320b that a particular pod 110 should enter the guideway 102 at a particular injection point during a particular time window. The pod control module 320b of the wayside controllers 210 can then use this guidance to determine more precisely when the pod 110 should begin moving, how fast the pod 110 should accelerate along the onramp, the speed the pod 110 should be traveling upon reaching the injection point, etc. Part of this determination may involve communicating with track sensors 460 and/or approaching, upstream pods 110 to determine their precise locations and speeds (or planned speeds), in order to inject at the appropriate time and velocity while avoiding collisions. The pod control module 320b of the wayside controllers 210 can then generate and convey appropriate instructions to the guideway 102, to the pod 110, or to both, to cause the pod 110 to move and enter the guideway 102 at the desired injection point during the desired time period in an appropriate fashion.

Alternatively, the pod control module 320a of the cloud 300 provides more granular guidance, and could provide more specific commands to the pod control module 320b of the wayside controllers 210, which the pod control module 320b can then pass on to the guideway 102 or the pod 110 (or both). Or, as discussed above, the pod control module 320b of the wayside controllers 210 could act without guidance from the cloud 300, based, for example, on information received from sensors in the guideway 102 or in the pod 110.

As discussed throughout this disclosure, in one embodiment the high speed transportation system 100 can include the wayside controllers 210 and central control of the pods 110 can be implemented through a combination of modules in the wayside controllers 210 and modules in the cloud 300. For example, in an embodiment, a central control system as described herein can be implemented through a combination of modules in the wayside controllers 210 and modules in the cloud 300. But in another embodiment, the wayside controllers 210 can be removed, and modules within the cloud 300 can communicate directly with the pods 110 and the guideway 102. Alternatively, the cloud 300 could be removed and modules within the wayside controllers 210 could perform the operations of modules of the cloud 300. When the following disclosure discusses a feature implemented by a module within the wayside controllers 210, this feature could instead be implemented by a module within the cloud 300. Similarly, when the following disclosure discusses a feature implemented by a module within the cloud 300, this feature could instead be implemented by a module within the wayside controllers 210.

The wayside controllers 210 illustrated in FIG. 2 is representative of a collection of computers that are located closer to the guideway 102, in terms of network latency, than the cloud 300. The wayside controllers 210 can be made up of any number of physical computers or processing devices with processors, memory, etc. In an embodiment, the physical computers making up the wayside controllers 210 can be dedicated computers located at various points near the guideway 102. For example, the wayside controllers 210 can be made up of computers located near injection points, near merge points, near portals, etc.

The computers within the wayside controllers 210 can communicate with the cloud 300 through the network 250. As discussed above, the network 250 can be any suitable communication network, including the Internet, a local access network, or a wide access network. The computers within the wayside controllers 210 can also communicate with the pod 110 through a communication link 220 as part of the guideway network 200. In an embodiment, the guideway network 200 is a local area network, and the communication link 220 is a link in the local network. The communication link 220 can also be a direct connection, or another high speed communication mechanism. In another embodiment, the computers within the wayside controllers 210 can communicate with the pod 110 using a wide area network, the internet, or any other suitable communication network. The wayside controllers 210 can also communicate with the guideway 102 through the network 250, or through any other suitable communication network. While FIG. 2 illustrates communication between the pod 110 and the cloud 300 through the guideway network 200, in an embodiment (and as discussed in more detail with regard to FIG. 3), the pod 110 can communicate directly to the cloud 300 through the network 250, or any suitable communication network. Similarly, the guideway 102 can communicate directly to the cloud 300 through the network 250, or any other suitable communication network.

The wayside controllers 210 generally include program code for performing various functions related to the high speed transportation system 100. The program code is generally described as various functional “applications,” “components,” or “modules” within the wayside controllers 210, although alternate implementations may have different functions and/or combinations of functions. For example, the wayside controllers 210 can include a pod control module 320b, a platooning module 322b, and a pod tracking module 340b. As discussed above, these modules can be used to supplement, or replace, modules executed within the cloud 300. In an embodiment, the physical computers making up the wayside controllers 210 are located in many different physical locations near the guideway 102. For example, the computers making up the wayside controllers 210 can be located near each injection point, each merge point, each portal, and each off-ramp in the guideway 102. In this embodiment, the computers making up the wayside controllers 210 are geographically specific, so that computers located near a pod 110 or a particular location on the guideway 102 physically, and in terms of network latency, can be used to perform actions related to that pod 110 or portion of the guideway 102.

In one embodiment, the wayside controllers 210 can include a route generation module. Like the route generation module 330 in the cloud 300, the route generation module in the wayside controllers 210 can be used to generate routes for the various pods 110 within the high speed transportation system 100. Operations related to generating routes can be divided between the route generation module 330 and the route generation module in the wayside controllers 210, or can be performed solely by route generation module 330 or the route generation module in the wayside controllers 210.

Further, the wayside controllers 210 includes a pod control module 320b. Like the pod control module 320a in the cloud 300, the pod control module 320b is generally configured to control the various pods 110 within the high speed transportation system 100, through commands to the guideway 102, commands to the pod 110, or both. As discussed in above, operations related to controlling the various pods 110 within the high speed transportation system 100 can be divided between the pod control modules 320a and 320b, or can be performed solely by the pod control module 320a or the pod control module 320b. For example, in an embodiment, the pod control module 320a in the cloud can provide general guidance, which the pod control module 320b can use to provide specific instructions to the guideway 102 and/or the pod 110.

The platooning module 322b in the wayside controllers 210, like the platooning module 322a in the cloud 300, facilitates various features related to platooning the pods 110. In embodiment, the platooning module 322b, and other modules within the wayside controllers 210, can receive reports from modules within the cloud 300, the guideway 102, and the pod 110. These reports can provide information about the current status of various items within the system 100, including the location of pods 110 within the guideway 102, the status of various parts of the guideway 102, temperature and weather information, traffic information, etc. Operations related to platooning can be divided between the platooning modules 322a and 322b, or can be performed solely by the platooning module 322a or the platooning module 322b. As an example, and as illustrated in FIG. 4, the platooning module 322b can detect approaching pods 110a-d upstream from an injection point 410, can determine when a pod 110e is ready for injection onto the guideway 102, can coordinate injection of a pod 110e onto the guideway 102 (e.g. at the appropriate time, acceleration profile, etc.), can coordinate platooning and linkage between the pods 110a-d and the pod 110e, and can report the success, timing, and position (absolute, or relative, e.g. other pods of a platoon), or any other suitable characteristic of an injected pod 110e to the platooning module 322a in the cloud 300.

FIG. 3 is an illustration of communication within a high speed transportation system. A pod 110 can communicate with the wayside controllers 210 and with the cloud 300. In one embodiment, the pod 110 communicates directly with the wayside controllers 210, and the wayside controllers 210 act as an intermediate layer between the pod 110 and the cloud 300. In another embodiment, the pod 110 can communicate directly with the cloud 300. As discussed above, this communication can use communication module 115 in the pod 110, and can use any suitable communication protocol. Further, each pod 110 can communicate with other pods 110. This communication can again use communication module 115 in the pod 110, and can again use any suitable network protocol. One example of a network protocol that may be suitable is IEEE 802.11p. In an embodiment, the pod 110 can also communicate with the guideway 102, through any suitable network connection.

The wayside controllers 210 can communicate with the cloud 300. The wayside controllers 210 can also communicate with the guideway 102. And the cloud 300 can communicate with the pod 110, the wayside controllers 210, and the guideway 102. Further, while the examples described herein focus on one cloud 300, in an embodiment the high speed transportation system 100 could have multiple clouds 300. Each cloud 300 can communicate with any other cloud 300.

FIG. 4 is an illustration of an example vehicle flow in a high speed transportation system 100. Four pods 110a, 110b, 110c, and 110d are traveling on guideway 102. These four pods 110a-d have formed a platoon 470. A pod 110e approaches an injection point 410. Depending on various factors, the pod 110e can join the platoon 470. A wayside structure 450 can be located near the guideway 102. The wayside structure 450 can include processors or other components that are part of the wayside controllers 210. Each pod 110a-e can communicate with the wayside controllers 210, as discussed above with reference to FIGS. 2 and 3. Locating the wayside structure 450 near the guideway 102 reduces the latency for communication between the wayside controllers 210 and the pods 110a-e. Locating the wayside structure 450 near the guideway 102 also reduces the latency for communication between the wayside controllers 210 and the sensors 460, along with any other components in the guideway, including motors, switches, etc. The wayside structure 450 can further include one more sensors 454. The sensors 454 can be used to sense properties of the pods 110a-e, properties of the guideway 102, and any other potentially relevant properties (e.g., air temperature or humidity). These sensors 454 can be located in a wayside structure 450, along the guideway 102, or in a combination of both. The location of the wayside controllers 210 near the guideway 102 also reduces latency for communication between the wayside controllers 210 and the sensors 454. The wayside structure 450 can further include a transceiver 452, for communication with pods 110a-e, with other wayside structures, with a cloud 300, with the guideway 102, and with other elements of the high speed transportation system 100. In embodiment, the transceiver 452 can be located in the wayside structure 450. In another embodiment, one or more transceivers 452 can be arrayed along the guideway 102. For example, the transceivers 452 could be locate upstream of the injection point 410, near the sensors 460.

Multiple track sensors 460 can be located along the track, upstream of the injection point 410. These track sensors 460 can be used to sense properties related to the platoon 470 or individual approaching pods, e.g., position, speed, estimated arrival at the injection point 410, etc. The track sensors 460 can also be used to sense any other relevant properties of the guideway 102 or pods 110. The track sensors 460 can be in communication with the pods 110, with the wayside structure 450 including the wayside controllers 210, or with a cloud 300. The guideway 102 can also include location beacons on, or near, the guideway 102. The location beacons can be used in routing and navigating the pods 110 on the guideway 102.

FIG. 5 is a schematic representation of a retention mechanism, according to one embodiment described herein. The retention mechanism 500 is for a carrier (e.g., a pod 110 as illustrated in FIGS. 1-4) and includes a retention feature 508, and an actuation mechanism 504. The retention mechanism 500 can optionally include a control system 502, a locking mechanism 510 and a set of sensors 506. In an embodiment, the retention mechanism 500 functions to mechanically retain a payload, on a retention substrate. The retention substrate can be, for example, a carrier, a loading bay, a vehicle, or be any other suitable surface.

In an embodiment, the retention mechanism 500 engages a payload attachment feature 512. Alternatively, the retention mechanism 500 engages any other suitable payload feature. In an embodiment, the payload attachment feature 512 is a set of payload wheels (e.g., an arcuate segment of the tire) for a user's vehicle. Alternatively, or additionally, the payload attachment feature 512 is the payload hub or rim, frame, hitch, hooks, or any other suitable attachment feature. In an embodiment, the set of payload wheels includes front wheels. Alternatively, or in addition, the payload wheels include the rear wheels, a single wheel, the right or left wheels, or any suitable set of wheels.

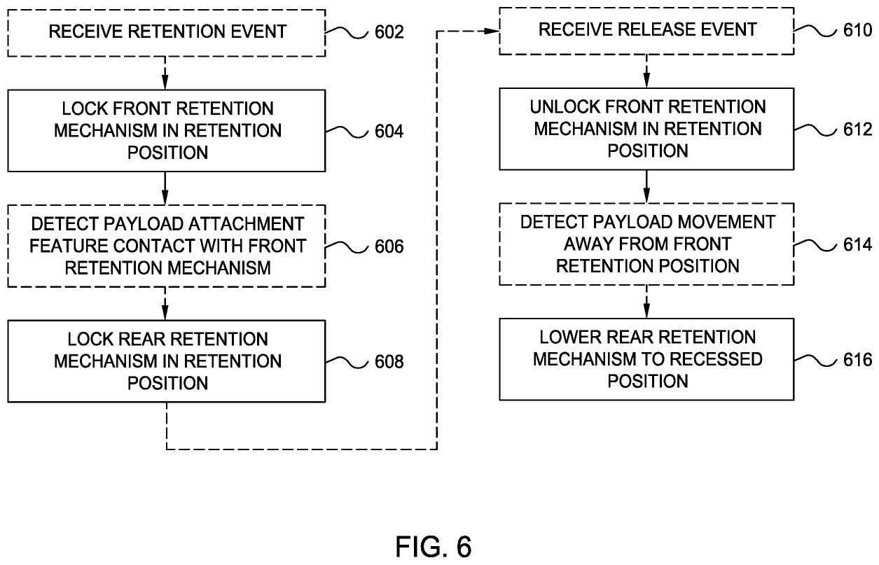

FIG. 6 is a flowchart illustrating operation of a retention mechanism, according to one embodiment described herein. At block 602, a control module in the carrier (e.g., the control module 114 illustrated in FIG. 2 or another suitable control module for a pod 110) receives a retention event. At block 604, the control module locks the front retention mechanism in the retention position. At block 606, the control module detects payload attached feature contact with the front retention mechanism. Alternatively, the control module otherwise senses that the payload is in position to be retained. At block 608, the control module locks the rear retention mechanism in retention position. At block 610, the control module receives a release event. At block 612, the control module unlocks the front retention mechanism in retention position. In an embodiment, the control module partially unloads the payload over the front retention mechanism. At block 614, the control module detects payload movement away from the front retention position. At block 616, the control module concurrently or sequentially actuates the rear retention mechanism (e.g., after payload forward motion is detected) to the recessed position to allow the payload rear to traverse forward to unload. The front retention mechanism can then be returned to the retention position.

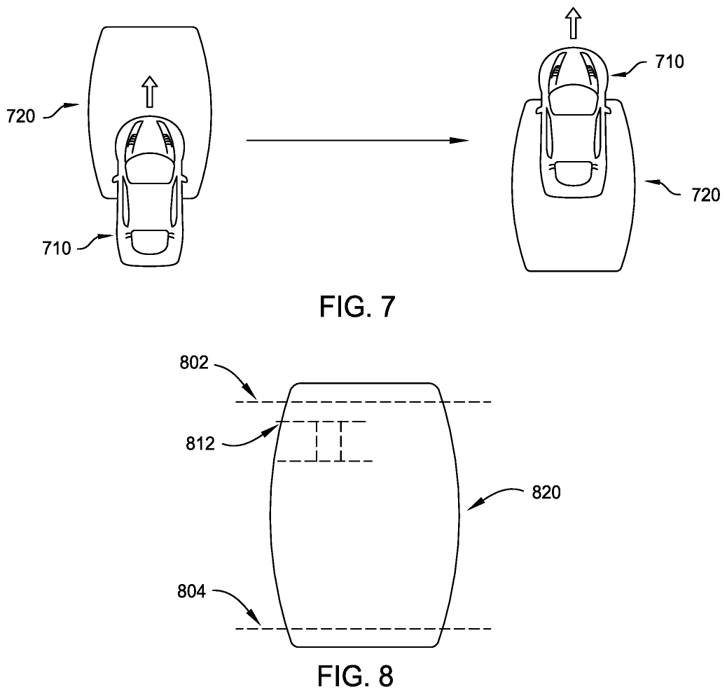

FIG. 7 is an example of a traversal path for a payload 710 through a carrier 720, according to one embodiment described herein. In an embodiment, the retention mechanism enables straight through access, wherein the payload 710 can traverse over the retention mechanism, but the retention mechanism can alternatively function to block payload traversal along a predetermined axis or operate in any other suitable manner.

FIG. 8 is an example of retention mechanism placement relative to a carrier's drive axle(s), according to one embodiment described herein. In an embodiment, the retention mechanism 812 is arranged along an interior of the carrier 820 (e.g., interior space defined by the carrier housing, interior surfaces, etc.), but can be arranged along the carrier exterior or along any other suitable surface, or partially along a lumen of the carrier and partially along the carrier exterior. The retention mechanism 812 can be mounted to the carrier platform, the carrier housing (e.g., front, back, sidewalls, etc.), the guidance mechanism(s) (e.g., guidance mechanism sidewalls), or to any other suitable surface.

In an embodiment, the retention mechanism(s) 812 are mounted between the carrier chassis axels/drive mechanism axles 802 and 804 (e.g., projection thereof onto the retention mechanism mounting plane). For example, the retention mechanism(s) 812 can be mounted between the levitation axles and outside the wheel axles. Alternatively, the retention mechanism(s) 812 be mounted outside of, aligned with, on opposing sides of, or at any suitable position relative to the drive mechanism axles.

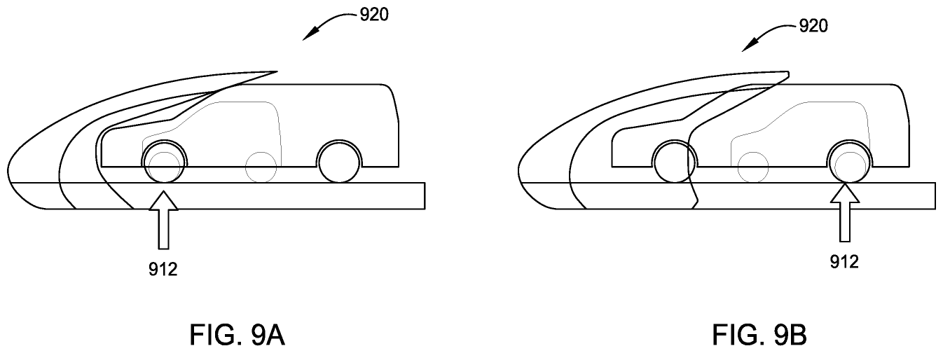

FIGS. 9A and 9B are examples of retention mechanism placement relative to the carrier, according to one embodiment described herein. In an embodiment, the retention mechanism can be fixed to the carrier (e.g., with a rotational axis fixed to the carrier), actuatable to the carrier (e.g., with a rotational axis that translates relative to the carrier), or otherwise mounted to the carrier. The retention mechanism can be mounted at a fixed or adjustable longitudinal position on the carrier. In an embodiment, as illustrated in FIG. 9A, the retention mechanism 912 can be mounted toward the front of the carrier 920 (e.g., spaced a predetermined length away from the carrier housing interior, such as a hood length away. Alternatively, as illustrated in FIG. 9B, the retention mechanism 912 can be mounted toward the rear of the carrier 920 or at any other suitable longitudinal position on the carrier 920. The retention mechanism can be mounted at a fixed or adjustable lateral position on the carrier. In one example, a first retention mechanism pair is mounted at a fixed position on the carrier, while a second retention mechanism pair (laterally aligned with the first retention mechanism pair) is mounted at an adjustable position on the carrier, which allows the carrier to accommodate for track width differences between different payloads. In a second example, a first retention mechanism pair is laterally adjustable, and a second retention mechanism pair is also laterally adjustable on the carrier, which allows the carrier to accommodate for track width differences between different payloads and which also allows the carrier to retain the payload in a position such that the payload's center of gravity is centered with the carrier.

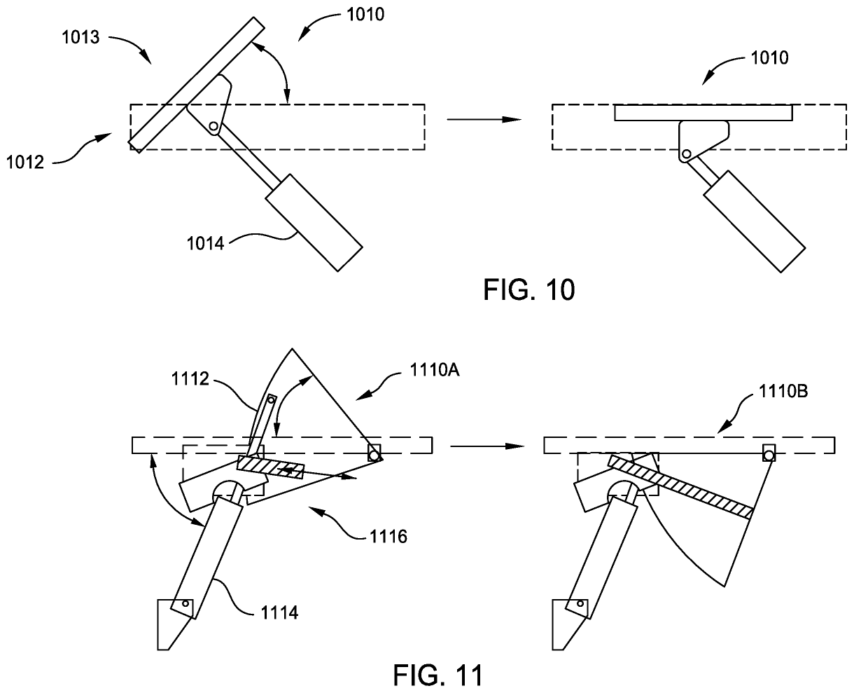

FIG. 10 illustrates one example of the retention mechanism in an engaged and disengaged mode, according to one embodiment described herein. The retention mechanism 1010 includes a retention feature 1012 and an actuation mechanism 1014. The retention feature includes a plate 1013, wherein a broad face of the plate forms the engagement surface. The rotation axis can be defined along a plate edge, outside the plate boundaries (e.g., wherein the plate forms an end link of a two- or three- or four-bar linkage), or otherwise defined. The actuation mechanism can be mounted partway along the plate height (e.g., along the plate center, along a face opposing the engagement surface), but can be otherwise mounted.

The retention mechanism 1010 can be operable between an engaged mode, a disengaged mode, and/or any other suitable set of operation modes. In the engaged mode, the retention mechanism 1010 can block payload traversal in a predetermined direction (e.g., forward, backward), and can optionally apply a predetermined or calculated or feedback-driven retention force to the payload. In an embodiment, the retention feature 1012 is arranged in the retaining position in the engaged mode. Alternatively, the retention feature 1012 can be otherwise arranged, such as raised between (e.g. midway between) the retaining position and the released or retracted position. In an embodiment, all or part of the retention feature 1012 is raised above the platform in the retaining position, but can be otherwise arranged. In an embodiment, the retention feature 1012 is arranged in the released position in the disengaged mode, but can be arranged in the retaining position (but not locked in the retaining position) or otherwise arranged. In an embodiment, all or part of the retention feature is flush with or recessed under the platform in the released or retracted position, but can be otherwise arranged. The retention mechanism may operate in an emergency mode—for example, if expecting a crash, active actuation mechanisms may be directed to apply as much force as possible to the attachment feature to provide a strong clamping effect.

The retention mechanism can be passively or actively controlled or both. Controllable operation parameters for the retention mechanism include: whether the retention feature position is locked or unlocked, the retention feature height, retention feature angle, the retention feature's lateral or longitudinal position, the retention force applied by the retention feature (e.g., by a single retention feature, by multiple retention features, etc.), the length of the retention feature (which may be lengthened or shortened), the power supplied to the actuation mechanism, or any other suitable retention mechanism parameter. In an embodiment, the retention mechanism operation parameters for the engaged mode, disengaged mode, or other operation mode are predetermined, but can be dynamically determined based on payload parameters (e.g. mass, size of wheels), carrier parameters (e.g., current or anticipated carrier dynamics, such as velocity or acceleration or deceleration), operation context (e.g., traffic, ambient temperature, ambient pressure, component temperature, weather, etc.) or any other suitable parameter; iteratively determined (e.g., to meet a target parameter value, such as a target payload shift amount); or otherwise determined. For example, the retention force can be predetermined (e.g., static), dynamically determined based on the payload parameters and/or carrier parameters (e.g., selected from a lookup table, calculated, estimated, etc.), or otherwise determined. In a specific example, the retention force is predetermined based on the payload tire parameters (e.g., width, radius, pressure). In a second specific example, the retention force is determined based on the payload mass and the carrier acceleration (e.g., wherein the retention force matches or exceeds the payload's applied force). Alternatively, the retention force can be dynamically adjusted when the payload's applied force exceeds a force rating associated with the tire (e.g., exceeds the tire's maximum allowed pressure). However, the retention force can be otherwise determined.

The payload parameters can include: payload mass or weight, mass or weight distribution (e.g., center of gravity), payload geometry (e.g., profile, 2D or 3D shape, width, height, length, ride height, track width, the difference between the front tires' track width and rear tires' track width, component dimensions, such as hood length, trunk length, or A-beam dimensions), the payload type or model, attachment feature geometry, position, or parameters (e.g., radius, width, tire pressure, tire location, tire temperature, tire traction, tire rating), payload geometry proximal the attachment feature (e.g., wheel well shape, aerodynamic feature presence or geometry), number of passengers, or any other suitable payload parameter. The payload parameter values can be received (e.g., from a user device, the vehicle, a central control system, an upstream sensing system, etc.), estimated, sampled (e.g., by a retention mechanism sensor, a carrier sensor, a precheck system sensor, etc.), calculated, determined using an artificial intelligence system, or otherwise determined. The artificial intelligence system (and/or any other suitable analysis module) can use one or more of: regression, classification, neural networks, heuristics, equations, libraries or lookup tables, instance-based methods (e.g., nearest neighbor), regularization methods, decision trees, Bayesian methods (e.g., Naïve Bayes, Markov), kernel methods, probability, deterministics, genetic programs, support vectors, cost function methods, or any other suitable method. For example, the force feedback from a force sensor of the retention mechanism can be used to determine the tire size (e.g., from the points of contact) and/or tire pressure (e.g., from the change in tire resistance). For example, the force feedback can be determined using current sensing for motor feedback (e.g., using a Hall effect sensor or other current sensor). In a specific example, the retention mechanism can be deemed to be in the retention position after power is applied and the current spikes, but the count output by a rotary encoder (e.g., magnetic absolute encoders, such as a Hall effect sensor, mechanical absolute encoders, optical absolute encoders, capacitive absolute encoders, or other encoder) monitoring actuation mechanism or retention feature angular position changes at less than a threshold rate (e.g., stops changing). However, the payload parameter values can be otherwise determined.

The retention feature 1012 of the retention mechanism 1010 functions to interface with the payload's attachment feature. The retention feature 1012 can function as a static barrier precluding movement in a predetermined direction (e.g. longitudinally), a barrier precluding movement in multiple directions (e.g., longitudinally, laterally, rotation, etc.), a retention force application mechanism, a sensor (e.g., to detect attachment feature rotation, slippage, or other movement, which can trigger notification generation), or perform any other suitable functionality. Each retention mechanism 1010 can include one or more retention features 1012 of the same or different type.

In an embodiment, the retention feature 1012 engages the attachment feature along an engagement surface of the retention feature 1012, but can engage the payload along any other suitable surface. In an embodiment, the retention feature 1012 is long enough to engage, for example, the attachment feature of various tire sizes, from small to large, yet short enough to clear the ground clearance of most cars. In an embodiment the engagement surface extends along a side or face of the retention feature 1012, but alternatively it can extend along an edge, along multiple sides/edges, various points, or extend along any other suitable surface. The engagement surface can be smooth, textured, include high friction materials (e.g., rubber), include coupling elements (e.g., adhesive, van der Waals elements, electromagnetic elements, etc.), or have any other suitable feature. The engagement surface can be concave outward, but can alternatively be convex outward or have any other suitable profile. The outermost region of the retention feature/engagement surface (relative to the pivot point of the retention mechanism) may be rectangular, or any other shape, e.g. it may be curved convexly outward, to increase surface area contact with the attachment feature and decrease the likelihood of a tire rupture when force is provided/received. The retention feature 1012 or engagement surface may also be shaped as a hook, which may engage payload (e.g. containers) at predetermined hooking points.

In an embodiment, the retention feature is actuatable about a rotation axis and/or along an actuation axis relative to the carrier platform (e.g., with the rotation plane parallel the payload or carrier longitudinal axis; perpendicular the payload drive axis; parallel the platform plane; etc.), but can alternatively be static. The rotation axis can be arranged within the retention feature in a corner contiguous with the retention feature's engagement surface, along a corner or edge opposing the engagement surface, or at any other suitable portion of the retention feature. In an embodiment, the retention feature 1012 is mounted to the carrier platform along the rotation axis, but can be mounted at any other suitable point. The retention feature 1012 can be mounted to the platform: top, bottom, interior, or any other suitable platform portion.

In an embodiment, the retention feature 1012 is actuated by one or more actuation mechanisms 1014, but can be otherwise actuated. The actuation mechanism(s) 1014 can be directly or indirectly mounted (e.g., via a plate, the locking mechanism, a linkage, etc.) to the retention feature 1012. The actuation mechanism 1014 mounting point can oppose the rotational axis across the retention feature center, be arranged along a common edge as the rotational axis, oppose the engagement surface across the retention feature center, be arranged at the rotational axis (e.g., wherein the actuation mechanism is coaxially aligned with and drives retention feature rotation), or be otherwise arranged. In an embodiment, the actuation mechanism 1014 is rotatably mounted to the retention feature, but it can be statically or otherwise mounted.

In an embodiment the retention feature geometry is static, but it can alternatively be adjustable. The retention feature geometry can be adjustable based on the payload parameter value (e.g., tire diameter), the carrier parameter value, and/or any other suitable parameter value. Adjustable geometry aspects can include: the length, height, slope angle, engagement surface profile, engagement surface roughness (e.g., wherein the engagement surface includes actuatable friction elements), or any other suitable aspect. In one example, the slope angle of the engagement surface is dynamically adjusted according to the following equation: slope angle=(retention feature height/wheel radius)*0.32. However, the slope angle can be otherwise adjusted. In another example, the length of the retention feature geometry is adjustable (longer for wider tires, shorter for smaller tires or less ground clearance) by, e.g., extending the feature; or by flipping over and positioning/locking a hinged secondary retaining feature relative to the primary retention feature; or by using a cam to varyingly adjust a top/end portion of the retaining feature/engagement surface.

FIG. 11 illustrates a further example of the retention mechanism in an engaged and disengaged mode, according to one embodiment described herein. A retention mechanism 1110 includes a retention feature 1112 and actuation mechanisms 1114 and 1116. As illustrated in FIG. 11, the retention mechanism 1110A is in retention position, while the retention mechanism 1110B is in retracted position. In this embodiment, the retention feature 1112 includes a chock, and a side of the chock forms the engagement surface. The chock can be a wedge, n-prism (e.g., polyhedron), twisted prism, have an asymmetric geometry, or have any other suitable shape. The rotation axis can be arranged in a corner contiguous with the engagement surface, wherein the rotation axis extends parallel the engagement surface width. The actuation mechanism(s) can be mounted to an edge opposing the rotational axis across the retention feature center or be otherwise mounted. FIG. 11 illustrates two actuation mechanisms 1114 and 1116—a spring and a linear actuator.

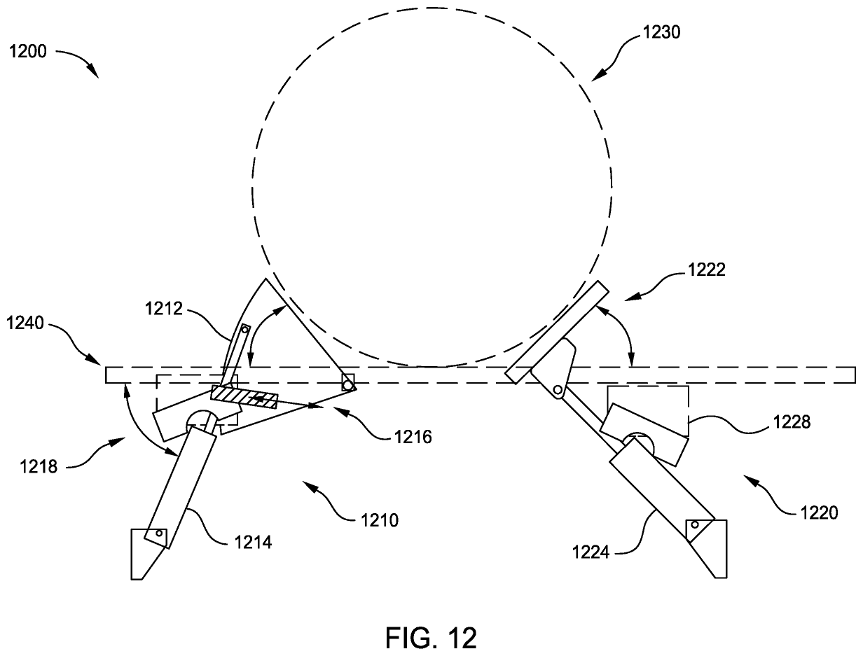

FIG. 12 illustrates an example of a retention mechanism pair engaging an attachment feature, according to one embodiment described herein. The carrier 1200 includes a pair of retention mechanisms 1210 and 1220 (e.g., a front retention mechanism 1210 and a rear retention mechanism 1220). The front retention mechanism 1210 includes a retention feature 1212, a primary actuation mechanism (return actuation mechanism) 1214, a secondary actuation mechanism 1216, and a locking mechanism 1218. The rear retention mechanism 1220 includes a retention feature 1222, an actuation mechanism 1224, and a locking mechanism 1228. In an embodiment, the pair of retention mechanisms 1210 and 1220 cooperatively engage the payload's attachment feature 1230 therebetween. The retention features 1210 and 1220 can be counter-rotatably mounted to the carrier platform 1240 (e.g., rotate outward and/or inward relative to each other); the actuation mechanisms 1214, 1216, and 1224 can be statically mounted to the platform 1240 (e.g., by a housing); the return actuation mechanisms 1214 and 1224 can be statically mounted at opposing ends to the retention feature and the platform; and the locking mechanisms 1218 and 1228 can be rotatably mounted to the retention features 1212 and 1222 (and lock against the platform 1240 or the actuation mechanisms 1214, 1216, and 1224). The front actuation mechanism (primary 1214 and secondary 1216) can be mounted to the front retention feature 1212 a predetermined distance away from the front retention feature's engagement surface and rotation axis (e.g., to increase the lever arm and generate more torque), while the back actuation mechanism 1224 can be mounted to the back retention feature 1222 at or near the back retention feature's engagement surface.

The payload can include passengers, goods, or a vehicle (e.g., a passenger car, truck, etc., which may itself contain passengers). The payload can include a payload control system, which may be instructed by and used by the pod control system (e.g., control module 114 illustrated in FIG. 2, or any other appropriate system) to control the operation of the payload (e.g. car) during loading/transit/unloading. For example, the pod control system may instruct a payload control system of a car to move forward, backward, or steer, as appropriate, during loading and unloading. As another example, during the loading process, the pod control system may instruct a payload control system of a car to switch to a parking mode or to engage its braking system after the car has been positioned in its retention position or retract its sideview mirrors or lower or adjust its spoiler or change its AC unit or lock doors or adjust other features, possibly until the carrier arrives at its destination and the pod control system engages the unloading process. The pod control system can provide instructions to the payload control system using any suitable network protocol, including IEEE 802.11b or any other suitable protocol. The instructions can be provided wireless or through a wired connection, through a direct connection or through a communication network.

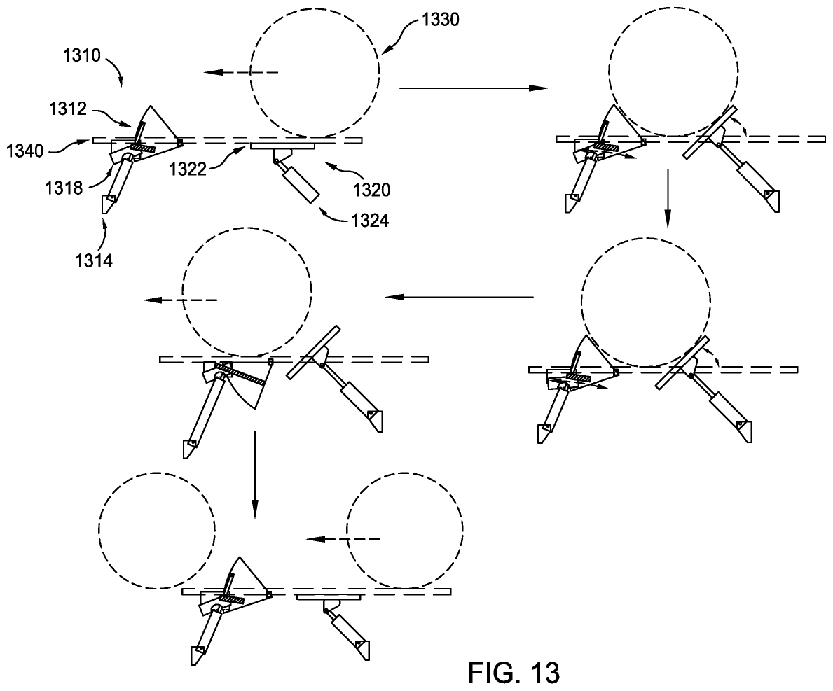

FIG. 13 illustrates a further example of a retention mechanism pair 1310 and 1320 engaging and disengaging an attachment feature 1330, according to one embodiment described herein. To engage the payload, the front return actuation mechanism 1314 biases the front retention feature 1312 to a retaining position, wherein the retention feature 1312 is raised above or proud of the platform 1340. The front locking mechanism 1318 locks the retention feature 1312 in the retaining position, and resists retention feature depression when payload weight and/or movement force is applied (e.g., when the payload is loaded and contacts the front retention feature). The front actuation mechanism 1314 can optionally apply a predetermined or feedback-calculated amount of force (e.g., to preload the retention feature) to augment the locking mechanism retention force when payload weight is applied. While the payload is being loaded, the rear actuation mechanism 1324 can bias the rear retention feature 1322 toward a retracted position (e.g., toward the platform), such that the engagement surface of the rear retention feature 1322 is flush with or recessed under the platform surface 1340. After the payload is loaded, the rear retention mechanism 1322 can be moved to the retention position by the rear actuation mechanism 1324 and/or an optional rear return actuation mechanism (which can bias the rear retention feature toward the retention position). To disengage the payload, the front actuation mechanism 1314 can actuate the front retention mechanism 1312 (e.g., rotate the front retention mechanism upward or downward; decrease the applied force) to release the front locking mechanism 1318 and allow the payload to move forward. The rear retention feature 1322 can concurrently or sequentially (after front retention feature disengagement) be released by actuating the rear actuation mechanism 1324 to pull the rear retention feature 1312 down toward the retracted position, which can allow following portions of the payload to move forward without restriction. The engagement—disengagement process can then be repeated for a second payload.

In a third example, the carrier includes a pair of retention mechanisms for retaining a payload's front wheel, wherein a front retention mechanism includes a retention feature, a primary actuation mechanism (e.g. spring), a secondary actuation mechanism (e.g. linear actuator), and a locking mechanism, and wherein a back retention mechanism includes a retention feature, an actuation mechanism (e.g. linear actuator), and a locking mechanism. To retain the payload, the front retention mechanism is locked in a retention position and the rear actuation mechanism biases a rear retention feature toward a retracted position (e.g., toward the platform), such that the engagement surface of the rear retention feature is flush with or recessed under the platform surface. The rear actuation mechanism may be locked by the rear locking mechanism in the retracted position. Upon a payload's attachment feature (e.g. wheel) contacting the front retention mechanism (or upon otherwise sensing that the payload is in position to be retained), the rear retention mechanism is moved to a retention position by the rear actuation mechanism and locked in that retention position. The rear actuation mechanism can optionally apply force to the payload's attachment feature (e.g. wheel) and preload the retention feature before the locking mechanism is engaged, substantially maintaining such force after locking. To release the payload, the locking mechanisms of the front and rear retention mechanisms are unlocked. The rear retention mechanism is actuated to a recessed or release position to allow the payload rear to traverse forward to unload. The rear retention mechanism may be locked in the recessed or release position.

In an embodiment, in this third example, the front retention mechanism is not actively actuated (and may not even have a secondary, active actuation mechanism)—instead, the payload attachment feature(s) (e.g. front and back wheels) drive over the front retention mechanism, passively depressing the front retention mechanism to a recessed or release position. After the payload attachment features (wheels) depress and pass over the front retention mechanism, the front retention mechanism returns to its retention position due to the passive operation of the front primary actuation mechanism (spring). After the payload unloads, the front retention mechanism is locked in its retention position so that the engagement—disengagement process can be repeated for a second payload. However, the retention mechanisms can be otherwise actuated.

Alternatively, should the payload be light and incapable of easily driving over and depressing the front retention mechanism due to the force of the front primary actuation mechanism (spring), the front secondary actuation mechanism can be actively controlled (e.g., actuated) to overcome such force, thus moving the front retention feature to a recessed or release position, whereupon it may be locked in the recessed or release position. After the payload has been unloaded, the front retention mechanism is unlocked and the primary actuation mechanism (e.g. spring) returns the front retention mechanism to its retention position, without any active use of the secondary actuator. The front retention mechanism is then locked in the retention position so that the engagement—disengagement process can be repeated for a second payload.

In a fourth example, the front retention mechanism can be raised to a mid-height position and latched. After the vehicle contacts the front retention mechanism, the front retention mechanism can be raised to the retention position and relatched. This variation can avoid obstacles proximal the wheel. However, the retention mechanism can operate in any suitable manner.

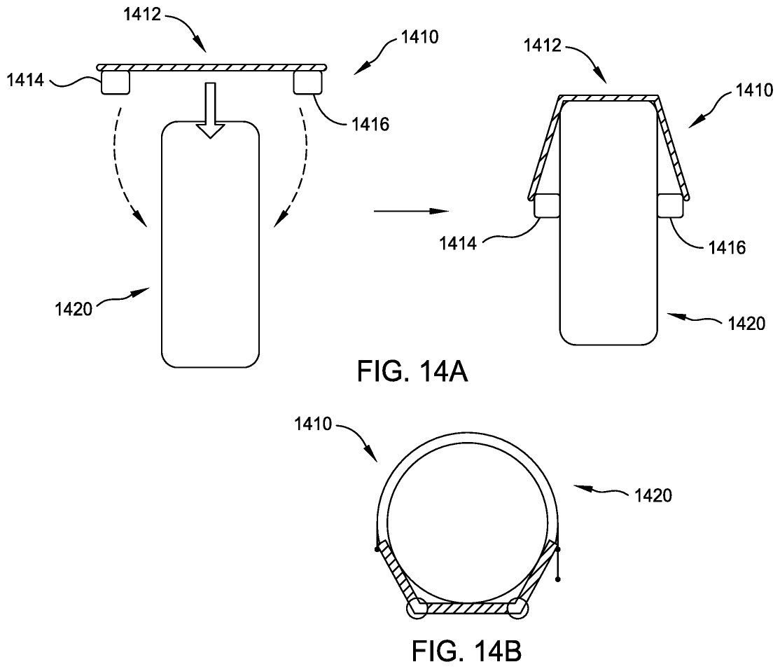

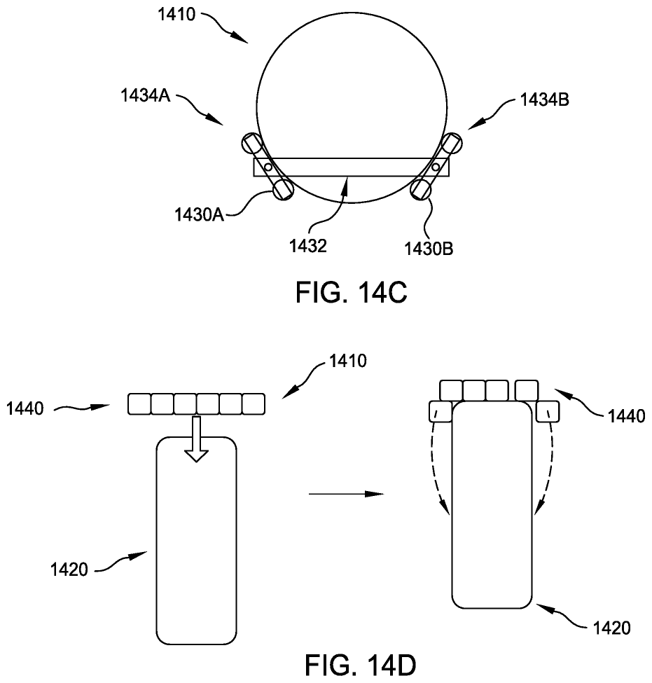

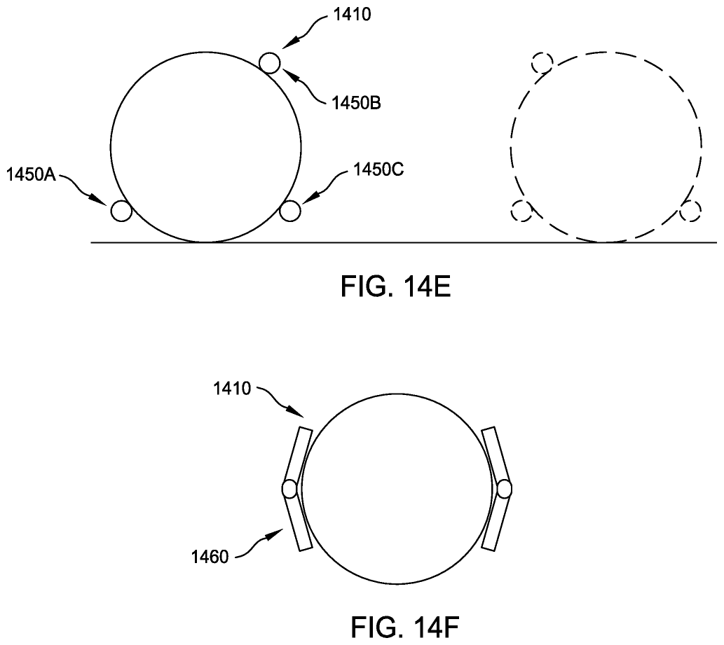

FIGS. 14A-14F illustrate further examples of the retention mechanism, according to one embodiment described herein. As illustrated in FIG. 14A, the retention feature 1412 includes a strap, wherein a broad face of the strap forms the engagement surface. In an embodiment, the strap is flexible, but it can alternatively be rigid. The strap can be elastic, non-elastic, or have any other suitable material property. The strap can be made of nylon, carbon fiber, Kevlar, or any other suitable material.

In an embodiment, the strap can wrap around a radial segment of the tire tread and sidewall. In this embodiment, the strap can be attached to a first mounting point 1414 (e.g., a post) and a second mounting point 1416 (e.g., a post) arranged on either side of the wheel 1420. In an embodiment, the techniques illustrated with regard to FIG. 14A are used for the rear retention mechanism of a retention mechanism pair. The posts are rotationally lowered before and as the payload's tire passes over the retention feature. After the payload's tire is in position for retention, the posts actuate rotationally about the payload's wheel axis (or an axis in parallel to that) to wrap the strap partially around the tire, thus providing both longitudinal and lateral support.

The front retention mechanism of the retention mechanism pair can be any appropriate retention feature, but is ideally a chock as shown in FIG. 11 and as described above. The mounting point 1414 can be statically mounted to the carrier (e.g., platform, wall, etc.), actuate longitudinally (e.g., along the vehicle length), actuate laterally (e.g., along the vehicle width), rotate about a post longitudinal axis (e.g., to wind the strap and control the strap length and/or tautness), or actuate in any other suitable manner. In one example, the mounting point 1414 can be fixed at a medial tire position (e.g., toward the center of a retained tire position), wherein the wheel 1420 engages and tightens the strap (extending between the posts) as the vehicle drives toward the retained tire position. A secondary retention mechanism (e.g., rear retention mechanism) can be used to bias the tire against the strap. Alternatively, one or both of the posts can be actuatable, wherein the strap tightening can move the posts inward toward the tire. In a further example, the posts can be raised from the floor of the carrier platform and then moved longitudinally to perform the wrapping.

FIG. 14B illustrates a retention mechanism 1410 in which the strap wraps about an arcuate segment of the tire tread on the wheel 1420. The arcuate segment can be a top arcuate segment, first and second arcuate segment opposing each other across a chord (e.g., diameter, chord parallel to the diameter, etc.), or be any other suitable arcuate segment. In this embodiment, the strap can be attached to the platform at a first end and to a roller, arranged with a rotation axis parallel the platform, at a second end. The roller can be rolled up along the tire arcuate profile while or after the tire has moved into the retained tire position.

FIG. 14C illustrates a retention mechanism 1410 in which the retention feature 1410 includes a first and second opposing bar 1430A and 1430B that engage a first and second arcuate segment opposing each other across an attachment feature chord (e.g., tire chord), wherein a broad face of the bar forms the engagement surface and the bars cooperatively form a cradle. In an embodiment, the bars are rigid and flat, but can alternatively be profiled (e.g., concave), flexible, or have any other suitable configuration or property. The bars can be connected by a crossbeam 1432. The crossbeam can actuate relative to the platform. The bars can be rotatably mounted to the crossbeam, statically mounted to the crossbeam, or otherwise mounted. The bars can be mounted along an intermediary mounting point (e.g., between the bar ends, be mounted at the bar ends, or mounted at any other suitable point. The bars can optionally include rollers 1434A and 1434B along the free ends, which can function to facilitate bar sliding along the tire surface. Alternatively, the crossbeam can be a tension rod, and extend between the front and back tires to engage the respective interior arcuate sections.

FIG. 14D illustrates a retention mechanism 1410 in which the retention feature includes an array of digitations 1440 extending out of the platform and configured to move relative to each other. In an embodiment, this variation of the retention feature is used for the rear retention mechanism of a retention mechanism pair. In operation, once the payload wheel 1420 is in position, the array 1440 rotates toward the attachment feature of the wheel, which upon contact stops the rotational movement of certain digitations and deforms the array 1440. The digitations can then be locked in their positions to prevent attachment feature translation both laterally, and longitudinally. Alternatively, the attachment feature can be pushed into the array, displacing the digitations and deforming the array after which the digitations are locked into place.

FIG. 14E illustrates a retention mechanism 1410 in which the retention feature include a set of rollers 1450A-C that operate in a similar manner to the rollers discussed above, with regard to FIG. 14B. FIG. 14F illustrates a retention mechanism 1410 in which the retention feature 1460 is shaped as a “C”, where the top and bottom portions of the “C” surround the attachment feature and inhibits or prevents the attachment feature from lateral movement (e.g. prevent tires from turning).

In another embodiment, the retention feature can include a groove in the retained tire position. This can further function as haptic feedback for the payload operator (e.g., driver). In another embodiment, the retention feature is the vehicle's braking system (e.g., parking brake, parking pawl, etc.), which can be manually engaged (e.g., upon instruction), automatically engaged (e.g., based on instructions automatically generated by the vehicle or transmitted to the vehicle from the carrier, precheck system, or other system. However, the retention feature can include hooks, adhesive, electromagnetic systems, and/or any other suitable system.

In connection with the retention mechanism techniques discussed above, the actuation mechanism of the retention mechanism can function to bias the retention feature toward a retention position, return the retention feature to a retention position, bias or return the retention feature to a release or retracted position, bias or return the retention feature to a position between a retention position and a release/retracted position, release the locking mechanism (e.g., by actuating the locking mechanism itself or releasing latching pressure applied by the retention feature), to augment or apply the retention force (e.g., the force applied by retention feature against the attachment feature, the force preventing retention feature position change), to actuate the locking mechanism toward the retention position (e.g., directly, indirectly by moving the retention feature), as a damper that absorbs shock from carrier acceleration/deceleration, or perform any other suitable functionality. The force applied by the actuation mechanism can be predetermined, determined based on the payload parameters (e.g., calculated, selected, etc.), dynamically determined (e.g., based on carrier parameters, payload parameters, feedback), or otherwise determined. For example, a higher retention force can be applied to larger tires, heavier payloads, faster carriers, cold tires, tires in low-temperature conditions, or tires on the side of an asymmetrically loaded payload.

In an embodiment, the actuation mechanism is statically coupled at a first point to the platform or the carrier and coupled at a second point to the retention feature, but it can be otherwise mounted. In an embodiment the actuation mechanism is mounted to the carrier underneath the platform, but it can alternatively be mounted above, along, or otherwise mounted relative to the platform. The actuation mechanism can be passive, active, or otherwise controlled. Examples of the actuation mechanism include: a spring (e.g., biased toward the retention position, biased toward the retracted position, etc.), direct drive, a linkage system (e.g., 4 bar linkage), a linear actuator (e.g., mechanical actuator, including a screw, wheel and axle, cam, or other rotary-to-linear converter; hydraulic actuator; pneumatic actuator; electro-mechanical actuator; linear motor actuator; telescoping actuator; etc.), a linear servo actuator, a rotary actuator (e.g., planetary gear, etc.), an electromechanical actuator (e.g., stepper motor, servomotor), fluid power actuator, or any other suitable actuation mechanism.

In one variation, the retention mechanism can include a control actuation mechanism and a return actuation mechanism. The control actuation mechanism can control the retention mechanism operation mode (e.g., by disengaging the locking mechanism, selectively adjusting the applied retention force, pulling the retention feature to a recessed or release position etc.), while the return actuation mechanism can return the retention feature back to the retention position and/or any other suitable position. In an embodiment the control actuation mechanism is actively controlled (e.g., by the control system), but it can alternatively be passive. In an embodiment the return actuation mechanism is passive (e.g., a spring), but it can alternatively be actively controlled. In one example, the control actuation mechanism is a pneumatic or hydraulic piston with a housing mounted to the carrier and the piston end mounted to the retention feature (e.g., opposing the rotational axis and the engagement surface). The return actuation mechanism is a spring, mounted to the carrier at a first end (e.g., underneath the platform) and mounted to an edge adjacent the engagement surface and the rotational axis. The spring is extended as the payload passes over the retention feature, and biases the retention feature toward the retention position after the payload is lifted off the retention feature. In a specific example, only the front retention mechanism includes the return actuation mechanism (e.g., be normally-raised) and the rear retention mechanism can lack the return actuation mechanism (e.g., be normally-lowered, while both can include the control actuation mechanism.

The retention mechanism can optionally include a locking mechanism, which functions to retain the retention feature's angular position in the engaged position, functions as a failover mechanism, functions as a shock mechanism (e.g., damping mechanism), or performs any other suitable functionality. Alternatively, the system can include a damping system (e.g., foam dampers, springs, etc.) arranged at the base of the actuation mechanism or otherwise arranged. The locking mechanism can prevent retention feature rotation away from the attachment feature, toward the rotation feature, axial translation, or prevent any other suitable motion. The locking mechanism can be passive, actively controlled (e.g., directly or indirectly controlled by a motor, by the actuation mechanism, etc.), or otherwise controlled. Alternatively, the locking mechanism can be the actuation mechanism. The locking mechanism can be on every retention mechanism, be on a subset of the retention mechanisms (e.g., the front retention mechanisms), or be on any other suitable set of retention mechanisms. Each retention feature can include none or one or more locking mechanisms. In an embodiment the locking mechanism rotates relative to the retention feature, but it can be rotatably mounted to the platform, the actuation mechanism housing, or otherwise arranged. The locking mechanism can lock against the platform, against the retention feature (e.g., wherein the retention feature can include teeth or another complimentary latching feature), the actuation mechanism (e.g., the housing, the piston, etc.), the retention feature's rotational axis, or against any other suitable surface. A passive locking mechanism can be a hardstop or barrier or lip against which a chock or plate may no longer further retract or depress.

In one variation, the locking mechanism is mounted to (and rotates relative to) the retention feature along a segment or edge proximal the actuation mechanism-retention feature mounting point. In this variation, the locking mechanism can latch against the actuation mechanism housing, wherein actuation mechanism extension can push the retention feature up and out toward the attachment feature. This allows the locking mechanism to passively engage with actuation mechanism (e.g., via gravitational force) to lock retention feature against the actuation mechanism housing (e.g., wherein the locking mechanism's rotation axis is mounted radially inward on the retention feature; the locking mechanism's engagement surface is arranged radially outward of chock center). The actuation mechanism can then be retracted to loosen the locking mechanism. However, the locking mechanism can be otherwise operated.

Examples of the locking mechanism include: a latch, such as a spring latch, slam latch, cam lock, or toggle latch (e.g., a claw or loop that catches a strike plate); lockset; pin; ratchet; clutch; magnet; or an electronic latch (e.g. a solenoid that drives a latching pin).

The retention mechanism can optionally include a set of sensors, which function to determine whether the payload is in place, whether the attachment feature in place, verify or monitor the retention parameters (e.g., retention force, retention position, payload shift, payload shock, etc.), verify or monitor the payload parameters (e.g., weight, weight distribution) during payload retention, carrier traversal, and/or payload release, or provide inputs or feedback for any other suitable set of processes. For example, the sensors can determine the applied current (e.g., and/or changes therein), which can be used to determine and/or control the applied retention force. The sensors can be arranged within the retention feature (e.g., along the engagement surface, rotational axis, etc.), the actuation mechanism (e.g., monitor the fluid pressure, monitor the power input, etc.), the locking mechanism (e.g., monitor the rotational position), the carrier (e.g., platform, walls, etc.), or in any other suitable component. Examples of sensors include: rangefinders (e.g., optical, acoustic; used to determine payload position, presence, and/or geometry); computer vision systems (e.g., using foreground/background segmentation, edge detection, corner detection, feature detection, ridge detection, Hough transforms, structure tensors, scale spaces, or other methods to perform vehicle profile matching; tire deformation analysis; etc.); profilometers or structured light (e.g., for vehicle geometry determination and/or matching; tire deformation analysis; etc.); force sensors (e.g., one or more of the following arranged in an array: pressure sensors, piezoelectric sensor, strain gauge, capacitive sensor, electromagnetic sensor, transducer, optical fiber, potentiometric strain sensor, resonant frequency stress sensor, thermal conductivity sensor, current sensor, such as a Hall effect sensor); position sensors (e.g., encoders, odometers, etc.); or any other suitable sensor.

In an embodiment the retention mechanism is mounted to the carrier. The carrier can additionally or alternatively include: a platform, a drive mechanism, a guidance mechanism, a track width accommodation, an enclosure, a pod control system, a sensor system, a passenger control system, a communications system, a proximity detection mechanism, or any other suitable component. As discussed above, the carrier functions as a conveyance or vehicle (e.g., a pod 110 illustrated in FIG. 1) that transports the payload through a high-speed transport system. In an embodiment the carrier is a personal carrier and configured to retain a limited payload (e.g. one automobile) containing a limited number of items (e.g. four humans with luggage) that allows for personalized and packetized transport. But the carrier can alternatively be a mass transit carrier configured to retain a payload with a large volume, mass, or number of items (e.g. 30+ humans). In an embodiment the carrier enables straight through access with a first and second opposing door, but it can alternatively include a single door (e.g., front, rear, or side loading), doors along contiguous sides (e.g., front and side doors), or enable any other suitable ingress and/or egress. The carrier can be unidirectional (e.g., travel in a single direction), bidirectional (e.g., travel in a first and second opposing direction), or be configured to travel in any other suitable manner, preferably along a guideway.

The platform of the carrier functions to mechanically support the payload. In an embodiment the platform is statically connected to rest of carrier and form the carrier floor, but it can alternatively be removably connected to the carrier (e.g., be a removable platform that converts a passenger payload to a standard interface, such that the carrier can interface with both passenger payloads and cargo). In an embodiment the platform engagement surface (e.g., top), includes traction features and/or materials, such as embossing, recesses, tread, rubber, serrations, or any other suitable feature or material. The platform can be thermally conductive or insulative, electromagnetically conductive or insulative, or have any other suitable material property.

In an example of carrier operation, the payload (e.g., vehicle) can drive onto the carrier (manually or automatically) until the payload's attachment feature (e.g., tires; front tires) is aligned with the retention mechanism (e.g., arranged within the retention mechanism active volume), and the retention mechanism can engage the payload's attachment feature (actively or passively; automatically or upon user instruction). The carrier can then traverse through the transport system to a predetermined endpoint. At the endpoint, the retention mechanism can disengage the payload's attachment feature, a section of the carrier housing can open (e.g., the carrier's aerodynamic shield can double as a door), and the payload can drive off the carrier in the same direction as payload ingress. The carrier can optionally raise a barrier (e.g., the rear retention mechanisms, a wall positioned behind the payload's rearmost wheels, etc.) to prevent payload reversal. However, the carrier can operate in any suitable manner.

One or more of the retention mechanism embodiments described herein can confer several benefits over conventional systems. First, variants of the retention mechanism can be automatic, wherein operators are not required for retention mechanism engagement and/or disengagement with the payload. For example, the retention mechanism can be passively biased toward a retention position (e.g., by a spring), passively retained in the retention position by a latch. The retention mechanism can also be automatically released from the retained position. For example, the retention mechanism can be actively released by the actuation mechanism (e.g., by actuating the retention feature away from the latch).

Second, variants of the retention mechanism can be bidirectional and enable payload ingress and egress in the same direction, which can enable faster loading and/or unloading. For example, variants of the retention mechanism can enable a vehicle to drive on and off the carrier, such that a driver of the vehicle does not have to reverse off the carrier, which is more difficult and slower than driving forward off the carrier.

Third, variants of the retention mechanism can be robust and highly repeatable, which can reduce operator monitoring and repair costs, and also decreasing the likelihood of failures. For example, leveraging passive return elements, such as springs, can reduce active component utilization and wear. In addition, passive return elements such as springs have fewer potential failure points than active actuators, which have more potential failure points, e.g. position sensors, software and control systems, associated wiring and circuit boards, power controls, and more complicated physical elements subject to wear and tear. As a further example, a retention mechanism may have one or multiple actuation mechanisms—a single actuation mechanism can by itself provide enough force to drive a retention mechanism; alternatively, an additional actuation mechanism(s) can provide additional force to help drive a retention mechanism; alternatively, an additional actuation mechanism can act as a failsafe by itself providing enough force to drive a retention mechanism.

Fourth, variants of the retention mechanism can retain the payload at a forward position of the carrier, which can bias the payload weight forward and arrange the payload closer to the aerodynamic shield. This can function to optimize aerodynamics (e.g., minimize rear payload exposure, bias the carrier nose downward to decrease lift, decrease turbulence between carrier aerodynamic shield and payload front), thereby: decreasing power consumption required to propel carrier and payload and following carriers, creating a smoother ride for payload, decreasing the amount of carrier suspension control required to ensure a sufficiently smooth ride for payload, decreasing the likelihood of loose components detaching from the payload. This can also function to ease carrier control (e.g., decrease the number of possible carrier weight distributions, which can minimize the complexity of levitation and/or suspension control), and/or confer any other suitable benefit.

In an embodiment, the retention mechanism is mounted to a carrier. Each carrier can include one or more retention mechanisms of the same or different type. In an embodiment, the carrier includes a retention mechanism pair that engages the payload attachment feature therebetween and may individually or cooperatively generate a retention force. However, the carrier can include a single retention mechanism or any suitable number of retention mechanisms. In an embodiment, each pair includes a front and rear retention mechanism (e.g., aligned along the carrier longitudinal axis), but can alternatively include a right and left retention mechanism or be otherwise arranged. The platform between a front and rear retention pair may be flat, or it may be a depression that provides feedback to a payload car driver indicating that the car has reached a proper retention position. In an embodiment the first and second retention mechanisms in the pair are arranged with parallel or aligned rotary planes (e.g., parallel rotational axes), but can be otherwise arranged. The carrier can include a single retention mechanism pair (e.g., that engages a single wheel), a first and second aligned retention mechanism pair (e.g., that engages the front wheels, back wheels, right wheels, or left wheels), a first and second cater-cornered pair, a retention mechanism pair for every payload attachment feature (e.g., 4 pairs), or any other suitable number of retention mechanism pairs. In an embodiment, the relative arrangement of the retention mechanisms within the pair (e.g., longitudinal separation distance or the distance between the respective rotation axes; lateral arrangement or relative arrangement of the rotation planes; etc.) is static, but can alternatively be adjustable (e.g., based on a payload parameter, carrier parameter, etc.). For example, the separation distance can be adjusted to accommodate tires of different radii.

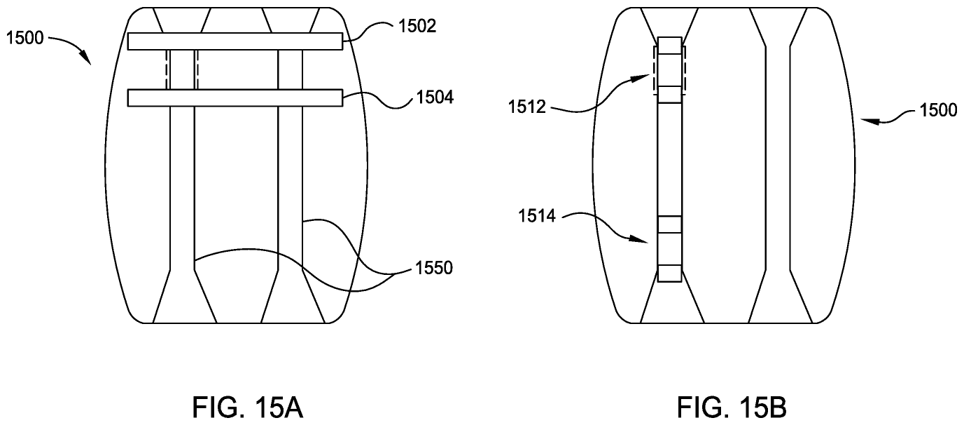

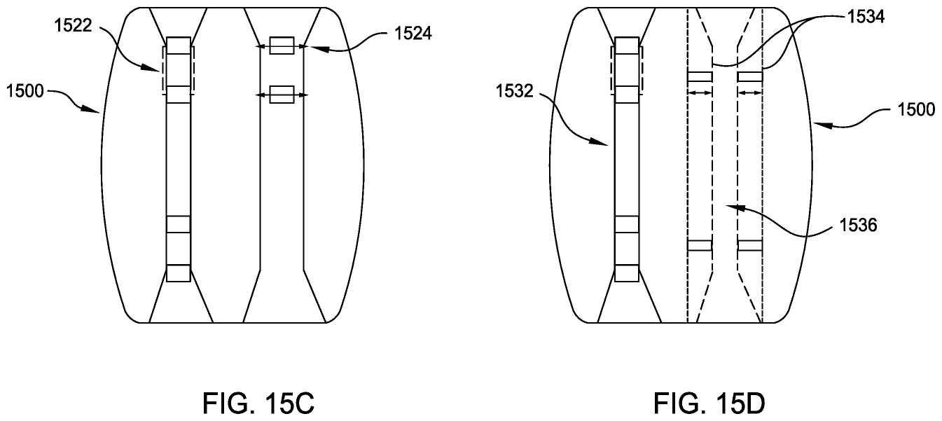

FIGS. 15A-15D are examples of retention mechanisms and guidance mechanisms for a carrier, according to one embodiment described herein. In one embodiment, a carrier 1500 includes a drive mechanism and a guidance mechanism. The drive mechanism of the carrier functions to generate the motive force that propels the carrier. The drive mechanism can be a linear electromagnetic motor such as a linear induction motor, a synchronous motor, a reluctance motor, a flux modulating or switching motor, or a homopolar motor; or it can be a non-electromagnetic motor, such drive wheels; or any other suitable motor mechanism; or a combination of the above. In one variation, the carrier can include a front axle, a rear axle, or any other suitable set of axles. The axles can be wheel axles, levitation axles, or any other suitable axle. In one example, the carrier can include a front and rear pair of levitation axles (and/or drive coils, aligned along a levitation axis) and a front and rear pair of wheel axles, wherein the levitation axles are arranged outward of the wheel axles. However, the carrier can be otherwise configured.

In an embodiment, the drive mechanism includes a levitation mechanism. The levitation mechanism of the carrier functions to vertically support the carrier. The levitation mechanism can be an electromagnetic levitation mechanism such as a linear induction motor, passive magnetic levitation system, an electromagnetic suspension system, an electrodynamic system, or a synchronous motor; or it can be a non-electromagnetic levitation mechanism such as wheels; or any other suitable levitation mechanism; or a combination of the above.

The guidance mechanism of the carrier functions to reliably guide the payload to the retained tire position, and can also retain payload along one or more axes. The guidance mechanism can be: mounted to platform, defined by the platform, defined by a removable secondary platform (which, in turn, mounts to the platform), or otherwise configured. In one embodiment, as illustrated in FIG. 15A, the guidance mechanism is made up of rails or grooves 1550 extending longitudinally along the platform and aligned with the retention mechanism rotary plane, wherein the retention mechanisms can be arranged within or along or beneath the guidance mechanism. The rails or grooves 1550 can guide the tire or wheel (e.g., interior and exterior surfaces), the payload body (e.g., lateral side panels), or any other suitable payload component. The rails or grooves 1550 can be profiled (e.g., wherein the walls converge toward the retention mechanism; the groove tapers inward toward the retention mechanism; the groove tapers outward toward the longitudinal extremities or portal interfaces; etc.), straight, or otherwise configured. The rails or grooves 1550 can be static, or adjustable in terms of lateral width to account for various payload dimensions (e.g. actuated or inflatable guide rails), or otherwise configured. For example, the interstitial width of the grooves can be dynamically adjusted (e.g., by laterally moving one or both walls; by changing the groove wall thickness, etc.) based on the payload track width. In another example, the rail width can be dynamically adjusted based on the payload track width.

The track width accommodation of the carrier 1500 functions to accommodate for vehicles with different track widths. The track width accommodation can optionally center the payload on the carrier. For example, as illustrated in FIG. 15D, the track width accommodation 1534 includes an adjustable guidance mechanism with actuatable lateral sidewalls. In one embodiment, the carrier 1500 includes a first guidance mechanism 1532 and a second guidance mechanism 1536. The first guidance mechanism 1532 can be static, while the second guidance mechanism 1536 can include actuatable sidewalls that actuate toward a guidance mechanism centerline until the sidewalls contact the tire. However, both guidance mechanisms can actuate to contact the tires (e.g., actuate inward, both actuate laterally in the same direction, etc.); the guidance mechanisms can be preset according to a known track width; or the guidance mechanisms can be otherwise actuated to accommodate for the track width.

In another embodiment, as illustrated in FIG. 15A, the carrier 1500 includes retention mechanisms 1502 and 1504 that are wide enough to accommodate for different track widths. In another embodiment, as illustrated in FIG. 15B, the carrier 1500 includes two retention mechanisms 1512 and 1514, wherein a first retention mechanism 1512 is narrow (and defines a predetermined payload retention point), while the other retention mechanism 1514 is wide to accommodate different track widths. In this variation, the drive mechanism (e.g., levitation mechanism) or suspension can be dynamically adjusted to accommodate for the offset weight distribution.

In another embodiment, as illustrated in FIG. 15C, one retention mechanism 1522 can be fixed while the other 1524 (or both) can be actuatable to engage the tire. In this variation, the retention mechanisms 1522 and 1524 can be different (e.g., one include a plate or wedge while the other include a strap). However, the track widths can be otherwise accommodated for.

In another embodiment, the guidance mechanism used with a carrier 1500 includes a set of parallel rollers that control motion in one direction (e.g., perpendicular the rotation axis). Alternatively, the guidance mechanism used with a carrier 1500 includes an instruction system. In one embodiment, the instruction system includes a location system, which determines the vehicle location within carrier, and can further function as a verification system (e.g., ensure that the vehicle is in the retained position before and during carrier operation). For example, the location system can include pressure sensors below expected payload wheel locations to determine whether the payload is in position. As another example, the location system can include a camera to detect the vehicle location within the carrier. As another example, the location system can determine the vehicle location within the carrier based on the current, power, or another electrical parameter, required to maintain the carrier's electromagnetic levitation with the payload in comparison to the current, power, or other electrical parameter required to levitate the carrier without the payload, and optionally also based the payload's and/or the carrier's known center of gravity. In a second embodiment, the instruction system includes an instruction module that generates driver or vehicle instructions (e.g., turn left/right/slow/speed up/move forward/stop/engage parking brake/put vehicle into specific drive state such as park, reverse, neutral, drive) to arrange payload that is a vehicle in a predetermined retention location (e.g., drive vehicle toward retention mechanism). The instructions can be predetermined, determined based on the measured or calculated position of the vehicle and the target position, or otherwise determined. The instructions can be verbal (e.g., oral, written); displayed on the user device, vehicle HUD, the carrier interior, interior of the carrier enclosure etc.), visual (e.g., lights, animations, simplified depictions of the vehicle's wheel in comparison to the retention mechanism(s)), vehicle instructions (e.g., transmitted to the vehicle from the carrier, track, user device, etc.), or have any other suitable format.

As discussed above, in an embodiment the carrier includes an enclosure. The enclosure of the carrier functions to aerodynamically shape the carrier or carrier with payload, and can optionally prevent undesirable payload egress and/or ingress. The enclosure can be a full enclosure, partial enclosure (e.g., front only, or front up to hood, optionally include: sidewalls, a roof, a rear, etc.), or encompass any other suitable portion of the carrier. The enclosure can further define one or more doors to facilitate payload ingress and/or egress. In an embodiment the door(s) are arranged along the longitudinal axis, but they can be otherwise arranged. The doors can open sideways, vertically, or in any other suitable axis.

Further, in an embodiment the carrier includes a pod control system. In an embodiment, the control module 114 illustrated in FIG. 2 functions as the pod control system. The pod control system of the carrier function to control all or part of the carrier operation, including retention mechanism operation and validation (e.g., that different processes had been performed), carrier translation control, drive mechanism control, sensor processing, or any other suitable process, including those mentioned above. As discussed above in relation to FIG. 2, the pod control system can include a microcontroller, CPU, GPU, or any other suitable system. In one variation, the user preferences, payload parameters, and navigation instructions (e.g., route instructions, switch instructions, etc.) are received from a remote system (e.g., a cloud 300 or guideway network 200, as illustrated in FIG. 2); while retention mechanism control and drive mechanism control are locally determined (e.g., using the pod control system). Alternatively, the user preferences, payload parameters, and navigation instructions (e.g., route instructions, switch instructions, etc.) for a pod not acting as a carrier (e.g., a pod carrying passengers directly, a pod carrying freight, or any other suitable pod) are received from a remote system (e.g., a cloud 300 or guideway network 200, as illustrated in FIG. 2); while drive mechanism control are locally determined (e.g., using the pod control system).

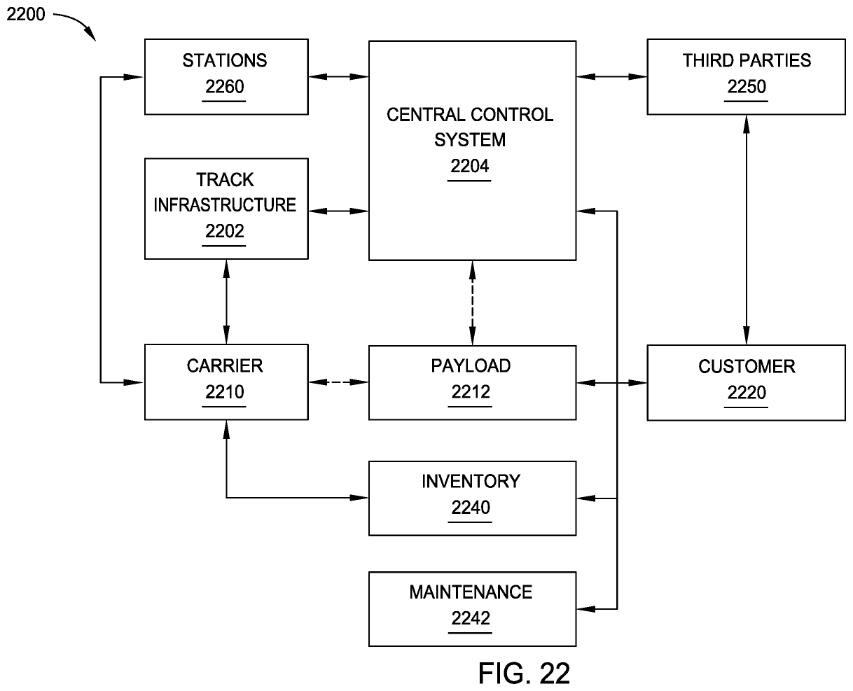

In one example, as discussed further below with regard to FIGS. 22-26, the pod control system functions to load payload onto the carrier. In a first step, the pod control system receives certain payload parameters (e.g. for use in adjusting the operation of the loading process or carrier accordingly). The payload parameters may be received directly from any suitable source, including a cloud server (e.g., the cloud 300 illustrated in FIG. 2), a wayside controller (e.g., the guideway network 200 illustrated in FIG. 2), a portal, etc. The payload parameters may be received occasionally and/or regularly (e.g. monthly) or upon each time the payload is to initiate a trip or arrives at a station (e.g., an injection portal) for loading. In an embodiment, an injection portal, as discussed above, serves as a station. Disclosure herein that refers to a station can refer to an injection portal. The payload parameters may be transmitted to the carrier in full, or only changed payload parameters may be transmitted to the carrier. The payload parameters may be received from the central control system unchanged or the payload parameters may be received as adjusted by the precheck system. For example, the track width of the payload (e.g. car) may be received directly from the central control system. Alternatively, the track width of the payload may be measured by the precheck system, updated by the precheck system, and sent to the pod control system, which subsequently adjusts the carrier guidance mechanism accordingly.

In a second step, the pod control system directs the locking mechanism of a front retention mechanism (of a pair of retention mechanisms) to lock in a retaining position. In a third step, the pod control system directs the retention actuation mechanism of a rear retention mechanism (of said pair of retention mechanisms) to lower to a recessed or retracted position. In a fourth step, the pod control system directs the locking mechanism of the rear retention mechanism to lock in the recessed or retracted position. In a fifth step, the pod control system adjusts the carrier guidance mechanism, optionally in accordance to received payload parameters. In a sixth step, the pod control system performs diagnostics on the front retention mechanism to ensure it is functional and in the up position, (e.g. to verify it has locked by engaging a secondary actuating mechanism of the front retention mechanism and detecting the position of the mechanism using position feedback)

In a seventh step, the pod control system performs diagnostics on the rear retention mechanism, e.g. to verify it has locked. In an eighth step, the pod control system instructs a payload computer to advance the payload forward toward the front retention mechanism. Alternatively, the pod control system instructs a payload driver to advance the payload forward toward the front retention mechanism. In a ninth step, the pod control system uses various aforementioned sensors (whether located on the carrier itself or on the station or as part of the precheck system) to detect the payload location, or whether the payload is in a proper retention location or proximal to a proper retention location (e.g. via a pressure sensor located between the pair of retention mechanisms, via a pressure sensor located on the front retention feature, via cameras and image recognition), optionally communicating with the station or precheck system to receive sensor data.

In a tenth step, the pod control system utilizes its instruction module to instruct a payload computer to stop or adjust the motion of the payload, such that the payload is in an acceptable payload retention position. Alternatively, the pod control system utilizes its instruction module to instruct a payload driver to stop or adjust the motion of the payload, through verbal instructions, written instructions, diagrammatically, video of the payload attachment feature and front retention mechanism, such that the payload is in an acceptable payload retention position. In an eleventh step, the pod control system directs the rear actuation mechanism to actuate and raise the rear retention feature to a retention position. In a twelfth step, the pod control system detects when the rear retention feature makes contact with the payload attachment feature (e.g. by detecting current or power spike while Hall counts remain steady).

In a thirteen step, the pod control system utilizes knowledge of when the rear retention feature made contact with the payload attachment feature, along with other parameters (e.g. known distance between the pair of retention features) to calculate tire size. In a fourteenth step, the pod control system directs the rear actuation mechanism to apply a preload pressure on the payload attachment feature. The applied pressure may be predetermined or be dynamically calculated. It may be received from the central control system or station (e.g. based on tire size, based on a table of pressures appropriate for each payload or each payload type or model, based on known payload parameters, based on parameters such as outside weather received from third party servers, etc.), or it may be calculated by the pod control system or pre-stored on the pod control system.

In a fifteenth step, the pod control system directs the rear locking mechanism to lock. In a sixteenth step, the pod control system performs diagnostics on the front and rear retention mechanisms, similar to the process performed in steps six and seven. In a seventeenth step, the pod control system verifies to the central control center and/or the station and/or adjacent track infrastructure, that it is ready to depart. In an eighteenth step, the pod control system engages its levitation mechanism and motive mechanism and departs the station. In a nineteenth step, the pod control mechanism monitors the retention mechanisms (e.g. by monitoring whether Hall counts change) to ensure they are functioning correctly.

In a twentieth step, the carrier arrives at the destination, unlocks the front locking mechanism, unlocks the rear locking mechanism, lowers the rear retention feature to a recessed position, locks the rear retention feature in the recessed position, runs diagnostics on the systems (e.g., using methods similar to those in steps six and seven), and instructs the payload (e.g., driver) to drive forward. The payload depresses the spring loaded front retention mechanism as it drives forward, wherein the front retention mechanism retracts under the vehicle weight. After the payload egresses from the carrier, the front retention mechanism is then locked in the retention position, diagnostics are again run on the systems (e.g., using methods similar to above), and the carrier can depart the station and/or move to a loading station. The pod control system can optionally inform the central control system that the payload has unloaded and/or the status of its retention mechanisms (e.g. they are in position and ready to receive another payload). In an embodiment, all of these steps are performed. Alternatively some, or none, of these steps are performed.

As discussed above with regard to FIG. 2, the carrier can optionally include a communication module (e.g., the communication module 115) that functions to communicate with the track, the precheck system, a central control system, the payload control system, the user device, and/or any other suitable system. The communication module can form a wireless connection, such as WiFi, a cellular network service, or any other suitable wireless connection, a short range field connection, such as radiofrequency, Bluetooth, NFC, or any other suitable short range field communication connection; a wired connection, such as a LAN line; or any other suitable connection.

The carrier can optionally include a set of carrier sensors (e.g., the sensors 116 illustrated in FIG. 2) arranged on the carrier interior and/or exterior, and can monitor payload parameters, carrier parameters (e.g., payload weight distribution on the carrier), or any other suitable parameter. The carrier sensors can be the same as or similar to the retention mechanism sensors and/or include: cameras (e.g., visual range, multispectral, hyperspectral, IR, stereoscopic, etc.), orientation sensors (e.g., accelerometers, gyroscopes, altimeters), acoustic sensors (e.g., microphones), optical sensors (e.g., photodiodes, etc.), temperature sensors, pressure sensors, flow sensors, vibration sensors, proximity sensors, chemical sensors, electromagnetic sensors, force sensors, trip wires (e.g., laser tripwire), or any other suitable type of sensor.

The carrier can optionally include a passenger control system, which functions to prevent passengers from exiting vehicle, exposing themselves to ambient environment, or engaging in other undesirable activities. In an embodiment, other pod configurations (e.g., a pod configured to carry passengers directly, or any other suitable pod) can also include a passenger control system. In an embodiment, the passenger control system includes the instruction module discussed above, which issues instructions to the user, payload, or other system to stop, engage the brakes, close the windows, lock the doors, or perform any other suitable process. Alternatively, the passenger control system can apply a physical fence, deploy airbags, or otherwise preclude passenger egress during traversal. Alternatively, the passenger control system can generate notifications, alarms, emergency stop instructions for the pod, or perform any other suitable action in response to passenger egress detection.

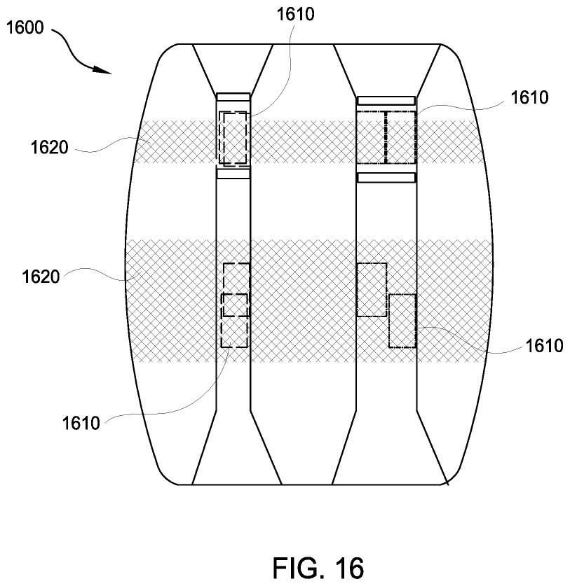

FIG. 16 illustrates an example of a carrier footprint, according to one embodiment described herein. A carrier 1600 (or upstream endpoint, such as a station or injection point) can optionally include a debris handling mechanism that functions to manage debris, including environmental debris (e.g., dirt, ice, snow, branches etc.) that can fall off the payload (e.g., the tire, body, etc.), particularly during high-speed operation where the carrier provides for a partial enclosure instead of a full enclosure. For example, a payload's tires can be located in the carrier at the locations 1610. The debris handling mechanism can include a debris removal mechanism that removes the debris from the payload, a debris collection mechanism that collects the debris, and a debris purging mechanism that removes the debris from the carrier. However, the debris handling mechanism can include any other suitable mechanism. The debris removal mechanism can include: serrations or protrusions 1620 on the platform and or retention mechanism (e.g. surface of the retention feature) that are better able to break apart ice when force is applied, compared to a flat surface; a heating element thermally coupled to the payload (e.g., resistive heating element, waste heat rerouting path that routes waste heat from the drive mechanism); or any other suitable debris removal mechanism. The debris collection mechanism can include: a reservoir (e.g., tray) connected to the platform surface by grating, grooves, or other fluid connections that extend along all or parts of the platform; the track external the carrier (e.g., fluidly connected to the carrier interior by holes or other fluid manifolds); or any other suitable collection mechanism. The debris purging mechanism can include: a drain to the ambient environment, a drain fluidly connected to the precheck station when docked, a set of fluid guides (e.g., vanes, baffles, etc.) that redirect the debris to a predetermined track section, a forced air system that selectively guides upstream air (e.g., from the track, through a front vent) to purge the debris collection mechanism (optionally to a predetermined track section), or any other suitable purging mechanism.

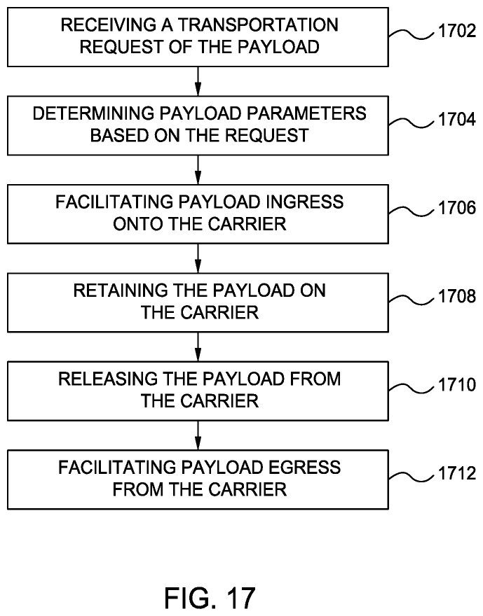

FIG. 17 illustrates payload loading and unloading, according to one embodiment described herein. At block 1702, a carrier control module (e.g., the control module 114 illustrated in FIG. 2) receives a transportation request for the payload. At block 1704, the carrier control module determines payload parameters based on the request. At block 1706, the carrier control module facilitates payload ingress onto the carrier. At block 1708, the carrier control module retains the payload on the carrier. At block 1710, the carrier control module releases the payload from the carrier. At block 1712, the carrier control module facilitates payload egress from the carrier. The techniques illustrated in FIG. 17 can optionally include: validating the payload identity, excluding payloads satisfying an exclusion condition (and/or including payloads satisfying an inclusion condition), and assigning a carrier to the payload. The illustrated techniques function to load and unload compliant payloads onto the carrier for transport through the transport system, and can optionally dynamically allocate carriers based on payload requirements.

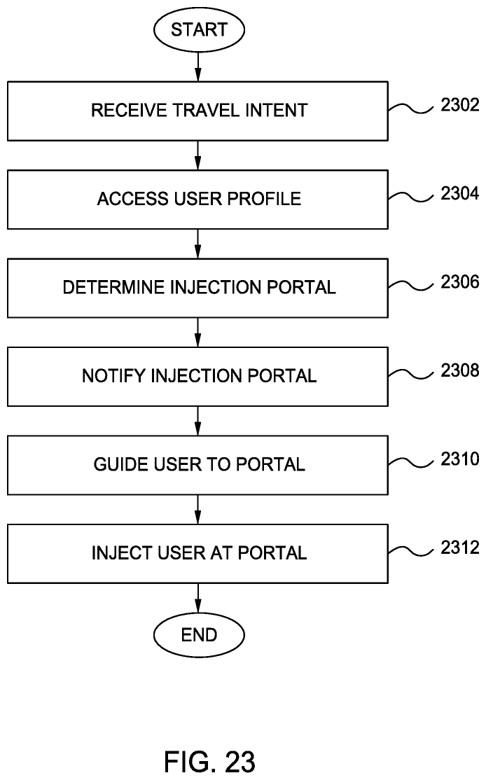

The techniques illustrated in FIG. 17 are discussed further with regard to FIGS. 23-26, and can be performed with a transport system including one or more: carriers as discussed above, precheck systems including at loading stations, unloading stations (which may be the same as loading stations), external guidance mechanisms, a central control system, and/or any other suitable component.

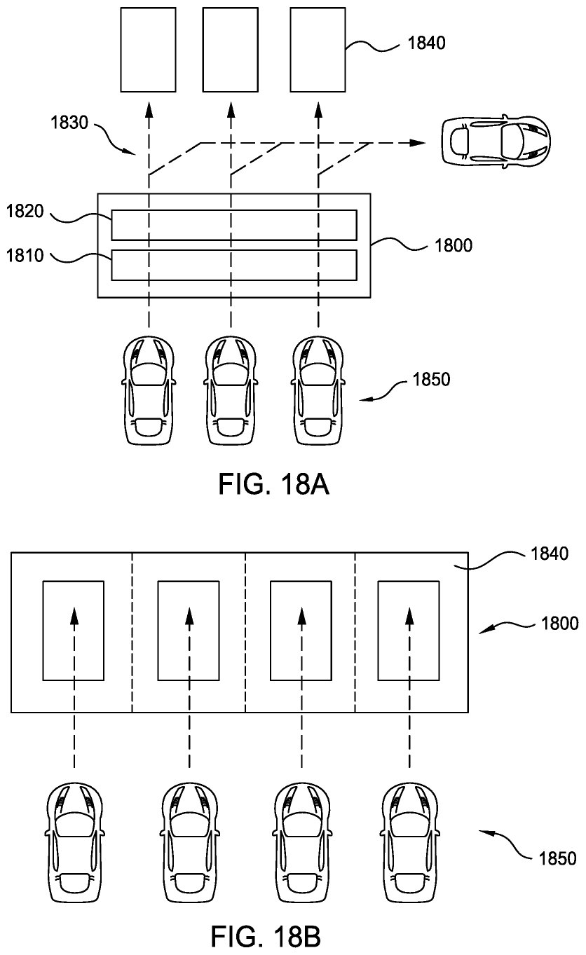

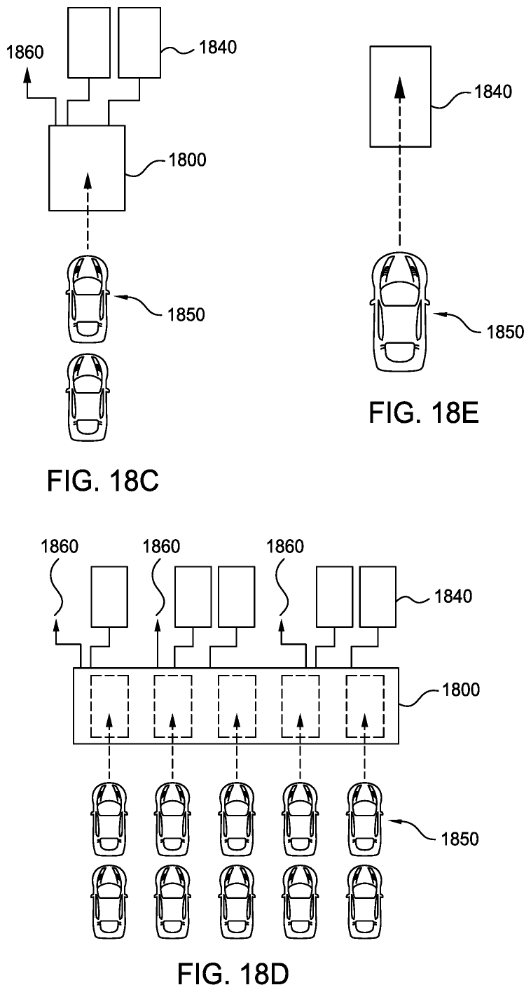

FIGS. 18A-E illustrate examples of a precheck system, payload, and carrier interaction, according to one embodiment described herein. A precheck system 1800 of the transport system functions to verify that the loading conditions are met before payload injection into the transport system (or into the main guideway/conduit). This is discussed further with regard to FIGS. 23-26, below. The loading conditions can include: the correct payload (e.g., verified identifier), payload parameters that satisfy a set of inclusion conditions and/or fail a set of exclusion conditions (e.g., within a threshold range, above or below a threshold value), or any other suitable set of loading conditions.

As illustrated in FIG. 18A, the precheck system 1800 can include an identification system 1810, a sensing system 1820, an external guidance mechanism 1830, or any other suitable subsystem. The subsystems of the precheck system 1800 can be aggregated into a unitary station, but can alternatively be distributed (e.g., between the road, the track, the carrier, the vehicle, the user device, the loading/unloading station, etc.) or otherwise configured. Each transport system can include one or more precheck systems. In one variation, the transport system includes a plurality of stations including the precheck system subsystems, wherein a plurality of payloads are loaded (and/or unloaded) from an auxiliary transport system (e.g. road) onto the carriers at the stations. In on embodiment, as illustrated in FIG. 18A, a station can load one or more payloads 1850 in parallel. Alternatively, a station can load the payloads 1850 serially, or in any suitable order. The stations can optionally store carrier inventory. Empty carriers 1840 awaiting payload loading may be stationed in front of the precheck system and/or payload, or behind, or to the side, or beneath or above. For example, unloaded carrier(s) may rise from beneath (from underground), after which the payload drives onto the carrier.

The stations and/or the precheck systems can optionally reroute noncompliant payloads (e.g., those satisfying an exclusion condition or failing an inclusion condition) to the auxiliary transport system (e.g., surface street). The station and/or precheck system can reroute the noncompliant payload before, after, or at the carrier loading point. For example, if the vehicle is non-compliant, the station directs the carrier to unload the payload in the immediate vicinity without switching onto a main guiderail at speed. Alternatively, the station directs the payload to reverse off the carrier.

In one embodiment, illustrated in FIG. 18A, a transport system includes a plurality of stations that include all or a portion of the precheck system 1800, wherein a plurality of payloads 1850 are loaded (and/or unloaded) from an auxiliary transport system (street) onto the carriers 1840. The precheck system 1800 or certain precheck subsystems are not immediately proximate to the carriers 1840 (e.g. do not surround the carriers or the carrier bays/docks) and are instead located before the carriers 1840, which allows for non-compliant payloads to exit prior to boarding a carrier, which may be advantageous in optimizing overall system loading speed. As shown in FIG. 18A, the number of station bays equal the number of carrier bays/docks, and each station bay corresponds to a specific carrier bay/dock, which may be advantageous in optimizing loading speed.

In operation, a payload 1850 drives to a station, and the precheck system 1800 operates on the vehicle, which may move without stopping at the precheck system 1800, or which may stop at the precheck system 1800. If the vehicle is non-compliant, the station reroutes the payload 1850 (e.g., those satisfying an exclusion condition or failing an inclusion condition) towards an exit, or a remedial portion of the transportation system, or the auxiliary transport system (e.g., surface street). If the vehicle is compliant, the station routes the payload 1850 to an appropriate carrier 1840. An appropriate carrier 1840 may be any available carrier or a carrier specifically designated by the central control system. An appropriate carrier 1840 may also be a carrier that the central control system has assigned because that particular carrier is suitable or more suitable for the payload. For example, based on payload parameters (e.g. car weight, tire size, ground clearance), the central control system may choose a carrier with a more appropriate retention mechanism, such as a longer retention feature for larger wheels, or a stronger rear actuating mechanism for more massive cars.

In another embodiment, illustrated in FIG. 18B, the transport system includes a plurality of stations that include all or a portion of the precheck system 1800, wherein a plurality of payloads 1850 are loaded (and/or unloaded) from an auxiliary transport system (street) onto the carriers 1840. The precheck system 1800 or certain precheck subsystems surround the carriers. As shown in FIG. 18B, the number of station bays equal the number of carrier bays/docks, and each station bay corresponds to a specific carrier bay/dock, which may be advantageous in optimizing loading speed. In operation, a payload 1850 (e.g. car) drives into a station and onto a carrier 1840. Because the precheck systems 1800 surround the carrier, the precheck systems 1800 may operate on the payload as the payload is in motion driving onto the carrier, which may be advantageous in decreasing the amount of time required for the loading process. If the vehicle is non-compliant, the station directs the carrier to unload the payload 1850 in the immediate vicinity without switching onto a main guiderail at speed. Alternatively, the station directs the payload 1850 to reverse off the carrier. In a subvariant, the identification system operates before the payload drives onto a carrier, and the identification system allows the central control system or station to select an appropriate carrier for the payload.

In another embodiment, illustrated in FIG. 18C, the transport system includes a station (including all or a portion of the precheck system 1800), wherein payloads 1850 serially egress into the station, are monitored by the station, and are assigned to a carrier 1840 or an exit 1860 if noncompliant. In another embodiment, illustrated in FIG. 18D, the configuration illustrated in FIG. 18C can be duplicated in parallel, and include multiple bays in lieu of individual stations. The bays can have individual precheck system components and/or share precheck system components

In another embodiment, illustrated in FIG. 18E, the transport system does not include a station, wherein the system can lack a precheck system, or include a carrier 1840 with all or a portion of the precheck components for the payload 1850 built in. In another embodiment, the precheck system (or a portion of it) is located on the carrier, and activated after the carrier has left the loading station/area with the payload loaded onto the carrier but before the carrier has entered a main guideway at speed. The precheck systems at this point may operate, e.g. the carrier may excite its drive/levitation elements and detect the response (e.g. to determine mass, COG, or the suspension response of the payload), and if the response is unsatisfactory, then the carrier proceeds at a safe speed (e.g. slowly) to an unloading station whereupon the payload is unloaded.

The identification system of the precheck system functions to identify the pod or payload by comparing a sensed or detected identifier to an expected identifier or to a list of acceptable identifiers. In an embodiment, the precheck system identifies a payload using a payload identifier associated with the payload. Alternatively, or in addition, the precheck system identifies a pod (e.g., a carrier pod, a pod configured to directly carry passengers, or any other suitable pod) using a pod identifier associated with the pod. In an embodiment, a central control system (e.g., the cloud 300 illustrated in FIG. 2, guideway network 200, or a combination of the two) transmits the identifier associated with the expected pod or payload to the precheck system prior to the arrival of the pod at the precheck system. Alternatively, the central control system transmits the identifier after the arrival of the pod or payload at the precheck system.

The identifier may be provided to the identification system occasionally, regularly (e.g. on a monthly schedule), each time that a pod or payload is expected to enter the transport system (e.g. upon the pod or payload requesting to enter the transport system for travel), or upon request (e.g., if a station does not recognize a detected payload and requests verification from the central computer or an updated list of identifiers from the central computer). Should the detected identifier match an expected identifier or acceptable list of identifiers, the precheck system allows the pod or payload to proceed with other checks or load onto an appropriate carrier.

Should the detected identifier not match an expected identifier or acceptable list of identifiers, the precheck system directs the pod or payload to exit the precheck system or the loading station or the transportation system, or performs additional steps to onboard the pod or payload into the central control system (e.g. by providing pod or payload details to the central control system or seeking identifier verification from the central control system) before proceeding further. In one embodiment, the identification system operates before the payload drives onto a carrier, and the identification system allows the central control system or station to select an appropriate carrier for the payload. The identifier can be used to verify that the correct payload is being loaded onto the carrier (e.g., wherein the determined identifier matches the payload identifier associated with the carrier), to verify that the correct pod is entering the transportation system, to determine (e.g., retrieve from the central control system) pod or payload parameters, or for other suitable purposes.

The identifier can be associated with other information to control entry. For example, the identifier can be associated with a limited time range during which the pod or payload may be accepted for entry into the transport system (e.g., at a specific price). The pod or payload parameters can be used to adjust pod operation (e.g., set maximum or minimum kinematic parameters, such as acceleration or velocity based on pod or payload mass, distribution, wheel radii, passenger characteristics, etc.), adjust retention mechanism operation (e.g., retention force, retention position, etc.), adjust external guidance mechanism of the loading/unloading stations, or otherwise used. The identifier can include: a user device identifier (e.g., MAC address, user account identifier, client or application identifier, etc.), vehicle identifier (e.g., license plate, VIN number, unique markings or scratches, etc.), a beacon frame address associated with the payload (e.g., MAC address), a transponder (or a transponder identifier associated with a transponder device), or any other suitable identifier. The identification system can include: a communication system (e.g., wired, wireless; short range or long range; WiFi, Bluetooth, NFC, RF, etc. that receives the broadcast beacon and for address extraction); computer vision system; or any other suitable identification system. The computer vision system can include one or more cameras (e.g., monocular, stereocamera, visible spectrum, invisible spectrum, infrared, hyperspectral, multispectral, etc.) coupled to one or more computer vision modules, such as a segmentation, feature detection, Hough transform, structure tensor, scale space, or other module. In an embodiment the identification system is arranged within the station, but it can alternatively or additionally be arranged within the pod, the track, the auxiliary transport system, or in any other suitable component.

In one variation, the identification system can include a computer vision system with the camera directed toward the pod or payload front or rear. In this variation, the computer vision module(s) can identify and read an external identifier on the pod or payload (e.g., license plate, QR code, barcode, etc.). In a second variation, the identification system can include a short-range communication system, wherein the pod, payload or user device transmits (e.g., broadcasts, unicasts, etc.) the identifier to the system. In a third variation, the system can retrieve the identifier from the endpoint (e.g., pod, payload, user device, etc.). However, the identification system can be otherwise configured and arranged.

The sensing system of the precheck system functions to determine pod or payload parameter values and/or perform any other suitable functionality. The pod or payload parameter values can be used to: update the pod or payload parameter values stored in association with a user account, pod, or payload; determine whether the pod or payload satisfies an exclusion or inclusion condition; adjust pod operation (e.g., set kinematic limits); adjust retention mechanism operation (e.g., select which retention mechanism to use; set the retention force; set shock accommodation operation parameters, etc.); or be otherwise used. The precheck system can include one or more sensing systems of the same or different type. The sensing system can be arranged within and/or be those of the station (e.g., within the wall, floor, external guidance mechanism, ceiling, etc.), the pod, the track, auxiliary transport systems (e.g., upstream or downstream from the high-speed transit system), the vehicle, the user device, or be otherwise arranged.

The sensing system can include one or more sensors. The sensors can include those discussed above for the pod, carrier system or retention mechanism, or include other sensors. Examples of sensors that can be used include: geometry sensors, mass sensors, kinematic sensors (IMU, gyroscope, accelerometer), electromagnetic (magnetometer), temperature sensors, location sensors (e.g., GPS, trilateration radios, triangulation radios), or any other suitable sensor.

The geometry sensor can include: a rangefinder (e.g., sonar, radar), profilometer (e.g., structured light sensor, interferometry system, focus detection system, pattern projection system, contact sensor, whiskers, probes, etc.), computer vision system (e.g., camera with a set of computer vision modules), or any other suitable sensor. In one variation, the computer vision system can be directed toward a longitudinal side of the pod or payload and extract features indicative of the pod or payload geometry, such as profile, ride height, or tire size (e.g., using foreground/background segmentation, etc.), and compare the detected profile to an expected or permitted geometry (e.g., predetermined geometry) for the identifier, type, class, or other characterization. Detected, permitted, and expected geometries may represent the pod or payload in two dimensions or three dimensions or by points or otherwise.

In this variation, the precheck system interior and/or surface opposing the vision system can have a predetermined color to ease segmentation and/or image processing, or be otherwise configured. In this variation, the precheck system can optionally constrain the available pod or payload poses (e.g., to a single pose), which can further reduce computational resources. When the detected profile differs from the expected profile by more than a threshold amount, the system can issue a notification (e.g., warning, instructions to rectify the discrepancy), route the pod or payload out of the transit system, or otherwise manage the discrepancy. However, the geometry sensor can be otherwise used. The detected profile can be (and at times should be) sent back to the central control system, which keeps parameters such as detected profiles stored and updated through time. The central control system can thus, for example, learn across multiple pods or payloads and detect when certain features for certain types of pods (e.g., certain pod configurations) or payloads (e.g. certain car models) frequently result in exclusion events, and alert an operator to such situations.

The mass sensor can include: an array of pressure sensors, the computer vision system (e.g., wherein the mass can be determined based on pod or payload motion responsive to pod, station, or other superstructure motion), the vehicle sensors (e.g., vehicle suspension sensor, tire pressure sensor, etc.), or any other suitable sensor. In one variation, the precheck system can include an array of pressure sensors embedded within the station floor, wherein the precheck system can measure the mass and mass distribution of the pod or the payload before carrier ingress. In a second variation, the precheck system can include a computer vision system (e.g., arranged along a first and/or second contiguous station wall) that detects the pod or payload pose (e.g., pitch, yaw, roll), wherein the mass can be determined from the decreased ride height (e.g., from a historic ride height, standard ride height for the pod or payload, etc.) and the mass distribution can be determined from the difference between the pod or payload pose and an expected pose (e.g., wherein mass is distributed rightward when the pod or payload is rolled rightward). In a third variation, the mass and distribution is determined from the pod or payload suspension compression, as determined by pod or payload suspension sensors. However, the mass sensors can be otherwise arranged and configured. This mass and mass distribution can be used to route the pod or payload out of the transit system (e.g., if the mass or distribution is above a threshold permitted level), dynamically adjust pod operation (e.g., increase the levitation force generated on the side with more payload mass), or otherwise used.

In one example, temperature sensors can be embedded within the station floor and measure pod or payload tire temperature, which can be used to control the debris management system (e.g., dynamically route waste heat from the drive mechanism to the platform floor or retention mechanism in response to temperature tires falling below a threshold temperature), adjust retention mechanism operation (e.g., increase force with lower temperatures), or otherwise used.

The central control system of the transport system (e.g., the cloud 300 illustrated in FIG. 2, guideway network 200, or a combination of the two) functions to control system operation. The central control system can store user parameters (e.g., user identifier, associated payloads, endpoints, routes, scores, etc.); individual payload parameters (e.g., up-to-date values, historical values, identifiers, etc.); generic payload parameters (e.g., expected geometries, models, etc.); carrier parameters (e.g., state of charge (SOC), age, drive mechanism performance, retention mechanism performance, associated payloads, etc.); or any other suitable information. The central control system can also store analysis modules (e.g., for sensor data analysis). Examples of analysis modules include: payload, track, or carrier characterization modules; payload-carrier assignment modules; navigation modules; routing modules; payload identification modules; or any other suitable module. The central control system can also monitor system component parameters (e.g., payload, track, carrier, user parameters) using sensor data from the sensor system(s), user request information, notification data, or any other suitable data. The central control system can include: a remote computing system (e.g., server system), distributed computing system (e.g., distributed across remote computing systems, control systems of the system, user devices, etc.), or any other suitable computing system. Additionally or alternatively, all or portions of the aforementioned processes can be performed by the user device (e.g., the client instance executing on the user device), the pod control system, the station control system, or by any other suitable system.

The central control system can be a centralized computing system, a distributed computing system or have any suitable configuration (e.g., a combination of the cloud 300 and the guideway network 200). The central control system preferably includes (e.g., executes) a set of modules (e.g., the modules 320, 322, 330, 340, 350, and 360 illustrated in FIG. 2), which cooperatively or individually perform different method processes. The set of modules can include analysis modules, control modules, or any other suitable set of modules. As discussed above the central control system coordinates and communicates with the various components of the transportation system and can function to: locate pods, route pods, platoon pods, switch pods among different guideways, control guideways, store and verify customer/passenger data, and store customer vehicle data. The central control system can optionally include a client that functions as an interface that is executed by a user device (e.g. smartphone) or by the pod or payload (e.g. automobile control system).

Receiving a transportation request for the pod or payload functions to initiate the loading process. The transportation request can be received from: a user device (e.g., wherein the user can request a carrier through a client executing on the user device), the pod or payload itself (e.g., the pod or payload automatically generates and/or transmits the request upon route initiation or proximity to a station), by the station (e.g., after receiving a pod or payload), or by any other suitable system. The transportation request can be received by: the central control system, the station control system, the pod control system, or by any other suitable system. The transportation request can include: a user identifier (e.g., wherein the payload parameters can be determined based on the payload associated with the user ID), a pod or payload identifier, routing information (e.g., time of arrival at a station, time of arrival at a destination, etc.), or any other suitable information.

Determining pod or payload parameters based on the request functions to determine whether the system can accommodate the pod or payload, determine parameters for carrier assignment, dynamically adjust retention mechanism operation, dynamically adjust system operation, or provide the informational basis for any other suitable subsequent process. For example, the maximum pod acceleration limit can be determined based on the wheel radius (e.g., lowered when the wheel is below a threshold size). In an embodiment the pod or payload parameters are determined for the pod or payload identified in the request, but they can alternatively be any other suitable pod or payload. The pod or payload parameters can be sampled, measured, retrieved, calculated, selected, or otherwise determined.

The pod or payload parameters can be determined by the precheck system or carrier (e.g., using the identification system, sensing system, etc.), retrieved from the central control system, or determined by any other suitable system. The pod or payload parameters can be determined before payload ingress onto the carrier, during payload ingress into the carrier, within a predetermined time window before payload ingress into the carrier (e.g., as the payload drives up to the carrier, as the payload is waiting in line, etc.), after payload ingress into the carrier, before a pod ingress into the system, periodically throughout pod or payload loading, transport, and unloading, or at any other suitable time. In an embodiment the pod or payload parameters are current pod or payload parameters (e.g., up-to-date, measured within a time window of payload ingress onto the carrier, etc.), but can be historical pod or payload parameters (e.g., used in lieu of current pod or payload parameters, used to reduce the analysis space for current sensor measurement analysis, etc.), or include any other suitable set of parameter values. Determining pod or payload parameters can include: determining the pod or payload parameter values (e.g., using the sensing system, as discussed above), determining the pod or payload identifier (e.g., using the identification system, as discussed above), retrieving the pod or payload parameters (e.g., from the central control system, as discussed above), or otherwise.

Carrier loading techniques can optionally include validating the payload identity, which functions to confirm that the correct payload is being loaded onto the carrier. In an embodiment validating the payload identity includes comparing the determined payload identifier with the payload identifier assigned to the carrier, but can additionally or alternatively include authenticating a cryptographic key (e.g., authenticating a public key using a private key), verifying a user ID-payload ID pair, or be otherwise validating the payload identity. Further, a pod can be validated prior to entering the system using a pod identifier, or another suitable techniques. The pod or payload identity can be verified by the precheck system, the station, the auxiliary transport system, the pod, the track, or by any other suitable system. In an embodiment the pod or payload identity is verified before the pod or payload enters the station, but can alternatively or additionally be verified: before, during, or after pod or payload parameter determination, after the pod or payload enters the station, before the payload enters the carrier, after the payload enters the carrier, before the pod enters the transportation system, or at any suitable time.

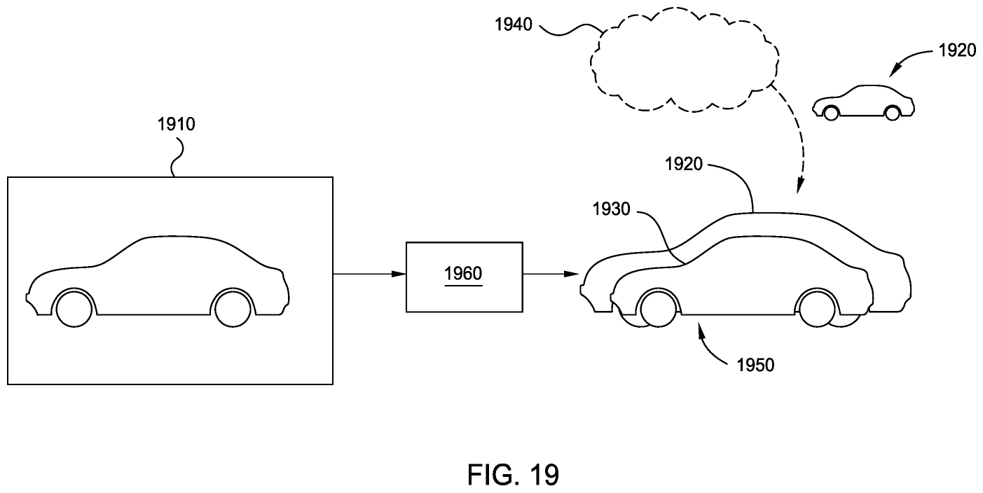

FIG. 19 is an example of determining pod or payload parameters, according to one embodiment described herein. Pod loading techniques can optionally include excluding pods or payloads satisfying an exclusion condition (and including pod or payloads satisfying an inclusion condition). This can function to filter out (e.g., remove, prevent) pod or payloads that the transport system is not equipped to handle from entering the transport system. Alternatively, pod or payloads satisfying an exclusion condition can be permitted into the system, but be charged more, payloads can be assigned to a different carrier type, pods or payloads can be routed along different routes, have different notifications be issued, or otherwise treated differently. In an embodiment, this is performed by the precheck system, station, auxiliary transport system, or other upstream system, but can alternatively be performed by the pod, the central control system (e.g., preclude or cease associated pod operation), or by any other suitable system. In an embodiment, this is performed before payload ingress onto the carrier or pod ingress into the transportation system, but can be performed after. For example, the precheck system (or a portion of it) may consist of the pod ready to be in injected into the system, the carrier having loaded the payload, the pod having departed onto a guideway onramp (but not yet having switched onto a main guideway at speed), and the pod exciting its drive/levitation elements and detecting the response (e.g. to determine mass, center of gravity, or the suspension response of the payload), and if the response is unsatisfactory and excluded due to an exclusion condition, then the pod proceeds at a safe speed (e.g. slowly) to an unloading station where any payload is unloaded. The pod or payload can be excluded when a predetermined number or type of exclusion conditions is met (e.g., a single condition), excluded when a predetermined number or type of inclusion condition is failed, or excluded upon occurrence of any other suitable event. The inclusion condition can be the opposite of the exclusion condition, or be any other suitable condition.

In an embodiment, as illustrated in FIG. 19, a payload 1950 is excluded if the detected profile 1930 differs beyond a threshold amount from the expected profile 1920. The embodiment illustrated in FIG. 19 is discussed in terms of a payload and carrier, but is equally applicable to a pod configured to carry passengers directly (e.g., without a payload), or any other suitable pod configuration. In this embodiment the pod (instead of, or in addition to, a payload) is profiled, validated, and included or excluded.

In an embodiment, an image 1910 of the payload is provided to the pre-check system using the pre-check module 1960. The pre-check module 1960 retrieves an excepted profile 1920 for the payload 1950 using the image 1910, or other suitable identifying information. In an embodiment, the expected profile 1920 is stored in the remote storage 1940 (e.g., the cloud 300 or guideway network 200 illustrated in FIG. 2) and provided to the pre-check module 1960 using a suitable communication network (e.g., the network 250 illustrated in FIG. 2). As illustrated in FIG. 19, the expected profile 1920 differs from the detected profile 1930. This can be indicative, for example, of aftermarket add-ons, such as roof racks or bike racks. If this difference exceeds a threshold amount, the pre-check module 1960 rejects the payload.

Other examples of exclusion conditions can include: the payload identifier differing from the payload identifier from the request; the payload mass or distribution exceeding a threshold value; the payload center of gravity exceeding a threshold distance from the front or rear; the payload (or component) volume, geometry, or other parameter exceeding a permitted volume, geometry, or other parameter value; a payload feature motion exceeding a predetermined frequency (e.g., wherein the frequency is associated with a loose feature); detection of a predetermined component presence on the vehicle (e.g., aerodynamic hubcaps or fairings), the detected debris (e.g., using computer vision systems, force sensors, etc.) exceeding a threshold amount or threshold coverage; and/or any other suitable exclusion condition.

The threshold or expected values can be: predetermined (e.g., retrieved from a reference database (e.g., the cloud 300 or the guideway network 200 illustrated in FIG. 2), dynamically determined (e.g., based on current system operation parameters (e.g., traffic, density, average velocity, etc.), or otherwise determined. In one variation, the expected values are retrieved from the central control system based on the user ID, payload ID, payload class, or any other suitable parameter. However, the threshold or expected values can be otherwise determined. The payload can be excluded by: the auxiliary transport system, the station, the carrier, the track, the payload itself (e.g., the system generates exclusion instructions for payload), the payload operator (e.g., wherein the system generates user instructions), or by any other suitable system component.

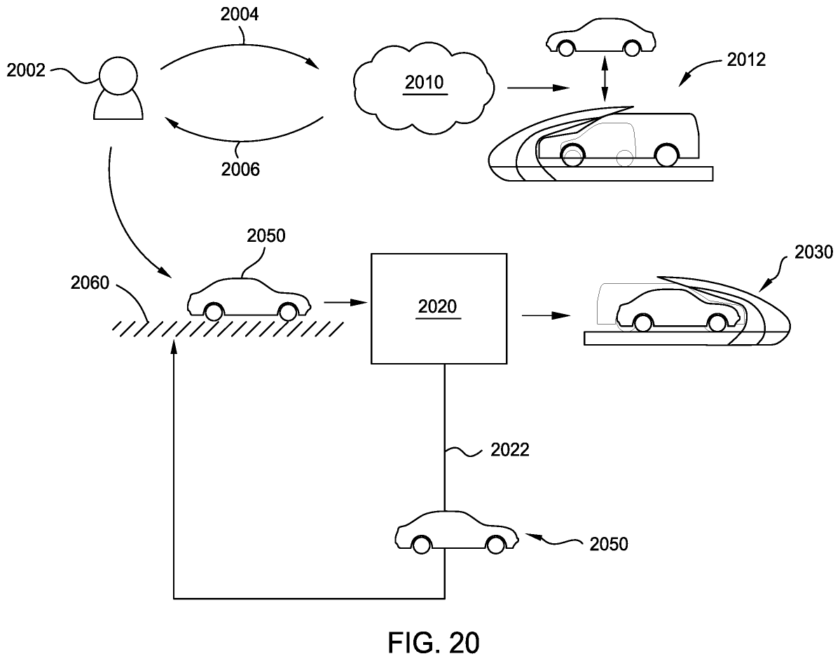

FIG. 20 is an example of payload loading and unloading, according to one embodiment described herein. The embodiment illustrated in FIG. 20 is discussed in terms of a payload and carrier, but it is also generally applicable to a pod configured to carry passengers directly (e.g., without a payload), or any other suitable pod configuration. In this embodiment the pod (instead of, or in addition to, a payload) is included or excluded from entering the transportation system.

In an embodiment, a payload 2050 is excluded by a station 2020, where the station 2020 includes a sensing system and identification system upstream of a switch in the external guidance mechanism. In an embodiment, a user 2002 transmits a request 2004 for entry into the system. A remote system 2010 (e.g., the cloud 300 or guideway network 200) retrieves a profile 2012 associated with the user's payload 2050, and transmits a response 2006 to the user 2002. In an embodiment, the response 2006 includes instructions and a carrier ID for use by the user 2002.

The payload 2050 enters the station 2020 (e.g., the user 2002 follows instructions in the response 2006 and drives into the station 2020). The payload 2050 is verified by the identification system and characterized by the sensing system as the payload moves toward the switch. When an exclusion condition 2022 is met (based on the determined payload parameters), the station can automatically switch the external guidance mechanism to a second mechanism (e.g., connected to an auxiliary transit system 2060). Additionally or alternatively, when the inclusion conditions are met (based on the determined payload parameters), the station can automatically switch the external guidance mechanism to connect to the carrier guidance mechanism and the payload can be loaded onto the carrier 2030.

In another embodiment, the system (e.g., vehicle, station, etc.) can automatically generate a notification when an exclusion condition is met. The notification can include instructions to exit the system, warnings (e.g., about impending noise due to fairing or payload bottom contact with the retention mechanism), or any other suitable information.

In another embodiment, the system (e.g., station, carrier) can physically preclude payload ingress onto the carrier, such as by raising a barrier in the payload path. However, the payload can be otherwise excluded.

As discussed above, the loading techniques can optionally include assigning a carrier to the payload. The assignment can be used to verify that the correct payload is on the carrier, and can optionally be used to generate routing instructions for the carrier and payload to arrive at the same station or docking bay within a predetermined time window. The carrier can be assigned by the central control system, the user device, the carrier, the station, or by any other suitable system. The carrier can be assigned to the payload: after request receipt, after carrier arrival at the station, as the payload is loaded onto the carrier, or at any other suitable time. The carrier can be assigned to the payload: ad hoc; based on the payload parameters; based on route parameters; based on carrier capabilities; or based on any other suitable parameter. In one example, a carrier with more than a threshold amount of power (e.g., higher SOC, more battery power) can be assigned to a payload with more than a threshold mass or a payload travelling longer than a threshold route. The central computer could calculate a power requirement for a payload given carrier mass, payload mass, altitude change(s), air density and/or expected drag, etc. and select and assign a carrier accordingly (e.g. with enough battery power, by communicating the requirement to an inventory store). As another example, one type of carrier has retention mechanisms with longer/stronger retention features (e.g. for trucks), and other type(s) of carriers have shorter/weaker retention features (e.g. for cars with small tire diameters or sports cars with low ground clearance), and the central computer selects and assigns carriers accordingly. However, the carrier can be otherwise assigned.

Facilitating payload ingress onto the carrier functions to load the payload 2050 onto the carrier 2030. In an embodiment this is performed by the station 2020, but can alternatively be performed by the payload 2050, the driver (e.g., the user 2002), or by any other suitable system. This can be performed after the payload parameters are determined, after the inclusion conditions are satisfied, or at any suitable time. In one embodiment, facilitating payload ingress includes instructing the payload (e.g., providing an instruction to the user 2002 as part of the response 2006) to drive toward the assigned station or carrier. The contents of the instruction can be adjusted or otherwise generated based on the payload parameter. For example, a scraping noise warning can be generated when an aerodynamic wheel feature is detected. In another example, the vehicle speed in the instructions can inversely vary with payload mass (e.g., slower speeds for more mass). In a second variation, facilitating payload ingress includes guiding the payload to the carrier interface with the external guidance mechanism (e.g., actively or passively). However, the payload can be otherwise guided to and/or loaded onto the carrier.

Retaining the payload 2050 on the carrier 2030 functions to restrain the payload 2050, such that the payload 2050 does not shift beyond a predetermined amount during carrier translation. In an embodiment the payload 2050 is retained by the retention mechanism discussed with regard to the Figures above, but can be otherwise retained. The payload retention parameters and/or retention mechanism operation instructions can be predetermined, determined (e.g., selected, calculated, etc.) based on a set of payload parameters, or otherwise determined. In one example, a lower retention force can be selected for tires with low pressure, hot tires, or small tires. In a second example, a different retention process can be selected for low ride heights and/or payloads with obstructed attachment features (e.g., as discussed above). However, the payload can be otherwise retained.

The loading techniques illustrated with regard to FIG. 20 can optionally include verifying that the payload 2050 is retained. This can include moving the carrier 2030 a predetermined distance or in a predetermined pattern (e.g., rolling, yawing, pitching, translating, etc.) and sampling measurements indicative of payload shift (e.g., using payload sensors, user device sensors, carrier sensors, retention mechanism sensors, etc.). Indicative measurements can include pressure shifts, noise patterns associated with payload shift, vehicle pose change (e.g., from computer vision systems), or any other suitable measurement.

Releasing the payload 2050 from the carrier 2030 functions to enable payload egress. In an embodiment the payload 2050 is released after carrier translation through the transit system, more preferably after carrier arrival at a second station, but can alternatively or additionally be released at any suitable time. In one variation, the payload 2050 is released after release instructions are received from the second station. In a second variation, the payload 2050 is released when the carrier kinematic measurements sampled by the payload's or carrier's on-board kinematics sensors (e.g., IMU, gyroscope, etc.) falls below a threshold velocity. In a third variation, the payload 2050 is released when the carrier is within a threshold distance of the second station (e.g., when the carrier is within the second station geofence, when the carrier receives a second station identifier, when the carrier connects to the second station's LAN, etc.). However, the payload can be released at any suitable time. In an embodiment the payload is released by the retention mechanism (e.g., controlled by the pod control system) in the manner discussed above, but can alternatively be released by the vehicle, manually released by the user, or otherwise released.

Facilitating payload egress from the carrier functions to unload the payload from the system. Payload egress can be controlled by: the pod control system, the station system, the vehicle, the user device, the central control system, or by any suitable system. Payload egress can be facilitated in the same manner as payload ingress, or be different. Payload egress can be performed concurrently or after payload release. In one variation, facilitating payload egress includes: opening the doors in the carriage (e.g., proximal the payload front, along the loading direction), releasing the retention mechanisms, and instructing the payload to drive out. The instructions can be predetermined, determined based on payload parameter values, or otherwise determined. However, payload egress can be otherwise facilitated.

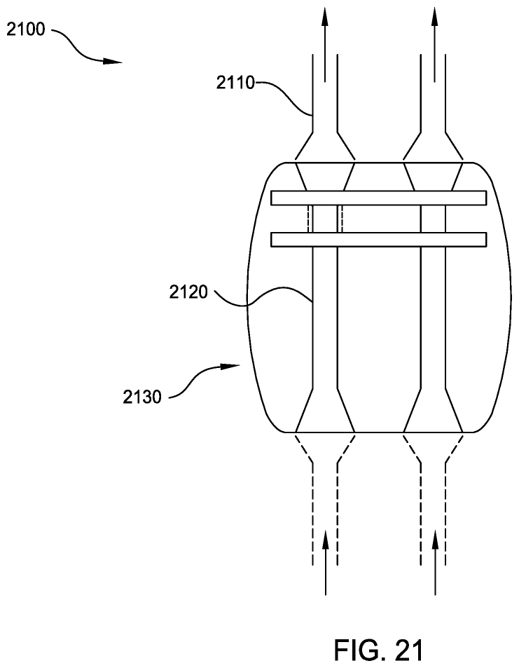

FIG. 21 is an example of an external guidance mechanism, according to one embodiment described herein. The external guidance mechanism 2110 of the precheck system 2100 (e.g., loading/unloading stations) functions to guide the payload to and/or from the carrier 2130. In an embodiment, the external guidance mechanism 2110 interfaces with and is aligned with the carrier guidance mechanism 2120, but can alternatively be a separate and distinct system. The external guidance mechanism 2110 may be dynamically changed according to received payload parameters (e.g. track width). In one embodiment, the external guidance mechanism 2110 includes a set of grooves or rails, similar to that discussed above for the carrier guidance mechanism. In another embodiment, the external guidance mechanism includes a unit load device, including a set of roller elements (e.g., bars, ball bearings) that can be actuated to transport the platform, retaining the payload, to the carrier. The roller elements can be passive, actively controlled (e.g., be electromagnetic and change direction with different power magnitudes or polarities), or otherwise controlled. However, the external guidance mechanism can be a conveyor, grooves with actuatable walls, or any other suitable mechanism.

FIG. 22 illustrates control systems of the transportation system, according to one embodiment described herein. In an embodiment, FIG. 22 corresponds with the system illustrated in FIG. 1, above. A transportation system 2200 includes a plurality of stations 2260 (e.g., the portals 160 illustrated in FIG. 1) in communication with a central control system 2204 (e.g., the cloud 300, guideway network 200 illustrated in FIG. 2, or a combination of the two). The transportation system 2200 further includes a track infrastructure 2202 (e.g., the guideway 102 illustrated in FIG. 1) suitable to transport a carrier 2210 and other pods (e.g., the pod 110 illustrated in FIG. 1). The carrier 2210 carries a payload 2212. In an embodiment, the payload 2212 is a vehicle driven by the customer 2220. The transportation system 2200 further includes an inventory system 2240 (e.g., the inventory center 140 illustrated in FIG. 1) and a maintenance system 2242. In an embodiment, the maintenance system 2242 is part of the inventory system 2240. Alternatively, the maintenance system 2242 is separate. The transportation system 2200 further includes one or more third parties 2250 (e.g., the airport 150 illustrated in FIG. 1) in communication with the central control system 2204.

FIG. 23 is a flowchart illustrating injecting a pod at a portal, according to one embodiment described herein. At block 2302 a pod control module (e.g., the pod control module 320a or the pod control module 320b illustrated in FIG. 2) receives a travel intent from a user. In an embodiment, the travel intent is a communication network message indicating that a particular user wishes to travel in the transportation system (e.g., on the guideway 102 illustrated in FIG. 1). In an embodiment, the user provides the travel intent as a travel request through an application or website on a mobile device (e.g., a mobile phone or tablet) or computer. Alternatively, the user provides the travel intent as a travel request through the user's vehicle (e.g., through a navigation system or other application in the user's car). In an embodiment, the user provides the travel intent through a graphical user interface (e.g., through selecting an icon or typing), through a voice command, or in any other suitable fashion. In an embodiment, the pod control module can interface with a user's calendar or schedule (e.g., a user's online calendar or electronic calendar) and can automatically determine the user's travel intent and form a travel request.

In an embodiment, the travel intent includes information about how the user wishes to travel through the system. For example, the user can request travel for him or herself along with his or her vehicle as payload. In this example, the user can travel to an injection portal using his or her vehicle (e.g., drive his or her car), and his or her vehicle can be loaded into a carrier pod as the payload, with the user (and any passengers) riding inside. As another example, the user can request travel using a pod configured for travel both on traditional roads and in the transportation system. In this example the user may have his or her own pod suitable for travel in both environments, and may transport him or herself (e.g., through automated travel or by driving) to an injection portal using this pod, where the pod will be injected into the transportation system. Alternatively, the user may request pickup at his or her origin (e.g., at home) from a pod suitable for travel on both traditional roads and in the high speed transportation system. The pod can pick the user up, carry him or her (along with any additional passengers and cargo) to an injection portal, and then be injected into the transportation system.

The travel intent can further include the number of passengers in the payload, information about luggage, information about cargo, etc. In an embodiment, the user provides this information when initiating travel. Alternatively, the travel intent can have a default value, which may be configurable by a user.

At block 2304, the pod control module accesses a stored profile for the user. In an embodiment, the travel intent discussed above with regard to block 2302 includes identification information for the user, the user's pod, or the user's payload. In an embodiment, the pod control module uses this identification information to retrieve a stored profile associated with the user, the user's pod, or the payload. In an embodiment, this profile is stored in a remote storage location in the cloud (e.g., the cloud 300) or the guideway network (e.g., the guideway network 200). For example, the profile can be stored in a suitable electronic database (e.g., a relational database or any other suitable database).

In an embodiment, the pod control module determines authorization for the user to travel in the transportation system. For example, the user profile can include information about the user's account status, including payment status. The pod control module uses the user profile, or other suitable information, to determine whether the user is authorized to access the transportation system.

In an embodiment, the pod control module further determines stored characteristics for the user's pod (e.g., pod suitable for travel both on traditional roads and in the transportation system) or payload (e.g., the user's vehicle) using the user profile. For example, if the user is traveling using his or her own pod, the user profile can include stored information about the make and model of the user's pod.

Alternatively, if the user is traveling using his or her vehicle as a payload, the user profile can include stored information about the nominal mass of the payload, the estimated center of gravity of the payload given the expected number of passengers, a two dimensional or three dimensional model profile of the payload, a license plate number associated with the payload, a transponder identification number associated with the payload, and other suitable information. In an embodiment, the two dimensional or three dimensional model profile is based on an expected profile for the user's payload (e.g., a profile for a standard model of the user's vehicle). This profile can come from a user, from a manufacturer of the payload (e.g., the vehicle manufacturer), or from another suitable source. Alternatively, the two dimensional or three dimensional model profile can be based on previous sensing of the payload during a previous trip on the transportation system.

In an embodiment, the user profile includes characteristics of the user or other passengers. For example, particular passengers may have medical or other characteristics that govern travel parameters (e.g., requiring less acceleration or lower speeds). This information can be stored in the user profile and used by the pod control module.

At block 2306, the pod control module (or another suitable module, e.g., the route generation module 330 or pod tracking modules 340a and 340b illustrated in FIG. 2) determines the injection portal to use when injecting the user into the transportation system. In an embodiment, the pod control module takes into account multiple factors in determining the injection portal, including the user's location, expected portal congestion, carrier availability, etc. For example, the pod control module can identify the user's location based on a GPS signal (e.g., from the user's mobile device or vehicle), based on input from the user, or using another suitable technique. As another example, the pod control module can take into account the model of the user's pod (if the user is traveling using his or her own pod). Alternatively, if the user is traveling using his or her own vehicle as a payload the pod control module can take into account the inventory storage status of carrier pods (e.g., stored at the inventory center 140), the availability of currently free carrier pods nearby various portal candidates, the availability of carrier pods that are currently carrying a payload but will soon be offloading, etc. In an embodiment, the pod control module identifies a portal where a carrier pod will be available to carry the user's payload.

In an embodiment, the transportation system includes one model of carrier pod for carrying any suitable payload. Alternatively, the transportation system includes multiple different models or types of carrier pods suitable for carrying different payloads. For example, the transportation system can include a heavy duty carrier pod suitable for carrying a heavier payload and a lighter duty carrier pod suitable for carrying a lighter pod. In an embodiment, the pod control module takes this into account when determining the injection portal.

Further, in an embodiment, the pod control module considers schedule constraints when determining the injection portal. For example, the user may be traveling to the airport and may have a flight scheduled at a particular time. The pod control module can take this into account when selecting an injection portal. Alternatively, the user can request arrival at the destination by a particular time. The desired arrival time can be provided by the user, or can be retrieved by the pod control module from a third party data source (e.g., an airport or airline data system, the user's calendar, or another source).

In a further embodiment, the pod control module considers priority information for the customer when determining the injection portal. For example, a customer may purchase higher priority travel for a particular trip for an additional fee, or may purchase lower priority travel for a discount. Further, the customer may be entitled to priority based on frequent travel or use of the transportation system. The pod control module can select an injection portal leading to faster (or slower) travel times based on the priority of the user's travel.

At block 2308, the pod control module notifies the selected injection portal that the user will be traveling using that portal. In an embodiment, the pod control module is located in the cloud (e.g., the pod control module 320a illustrated in FIG. 2) and transmits a notification to a wayside controller (e.g., the pod control module 320b in the wayside controller 210 illustrated in FIG. 2) to expect the user's arrival. In an embodiment, this wayside controller is located at or near the selected injection portal. Alternatively, the wayside controller is in network communication with the selected injection portal. In another embodiment, the pod control module is located in a wayside controller.

In an embodiment, the pod control module transmits to the wayside controller identification information for the user (e.g., a license plate number or transponder identifier associated with the user's pod or payload). Further, the pod control module can transmit additional information associated with the user's pod or payload to the wayside controller, including the expected two dimensional or three dimensional profile for the pod or payload, the expected mass of the pod or payload, the expected center of gravity for the pod or payload, etc. Further, the pod control module can provide to the wayside controller the maximum allowable parameters for the pod or payload, for example the maximum mass, the maximum center of gravity across each of the (x, y, z) axes, etc. Alternatively, the wayside controller can maintain this information. In an embodiment, the pod control module transmits the required information as necessary for use by the wayside controller (e.g., once when the user initiates travel, once per hour, once per day, etc.).

At block 2310, the pod control module guides the user to the selected injection portal. In an embodiment, the pod control module provides guidance information to the user. For example, the pod control module can interface with an app or website on the user's mobile device (e.g., mobile phone or tablet) to provide guidance for the user to drive to the selected injection portal. Alternatively, the pod control module communicates with the user's pod or payload (e.g., the user's car) to provide guidance to the selected injection portal. Any suitable communication protocol can be used, including IEEE 802.11p, LTE-V2X and other suitable wireless access in vehicular environment (WAVE) protocols.

In an embodiment, the user is guided to the selected injection portal through audio or visual cues. For example, a pod or payload (e.g., a user's vehicle) can provide visual information on a display or navigation system and audio information over a vehicle's audio system. Alternatively, a user's mobile device could guide the user through audio or visual cues (e.g., using a mobile app or website). In an embodiment, the audio and visual cues can be instructions (e.g., turn left or right), diagrams or maps, lights, etc. Further, the injection portal itself can include audio and visual cues to assist in guidance as the user approaches. Further, as discussed above, the user can be guided through a carrier guidance system (e.g., a track or groove) in a carrier pod itself.

In another embodiment, the pod control module instructs the user's pod or payload to automatically travel to the injection portal. For example, the pod or payload may be a vehicle with autonomous transport capabilities. The pod control module can provide an instruction to the pod or payload to travel to the selected injection portal.

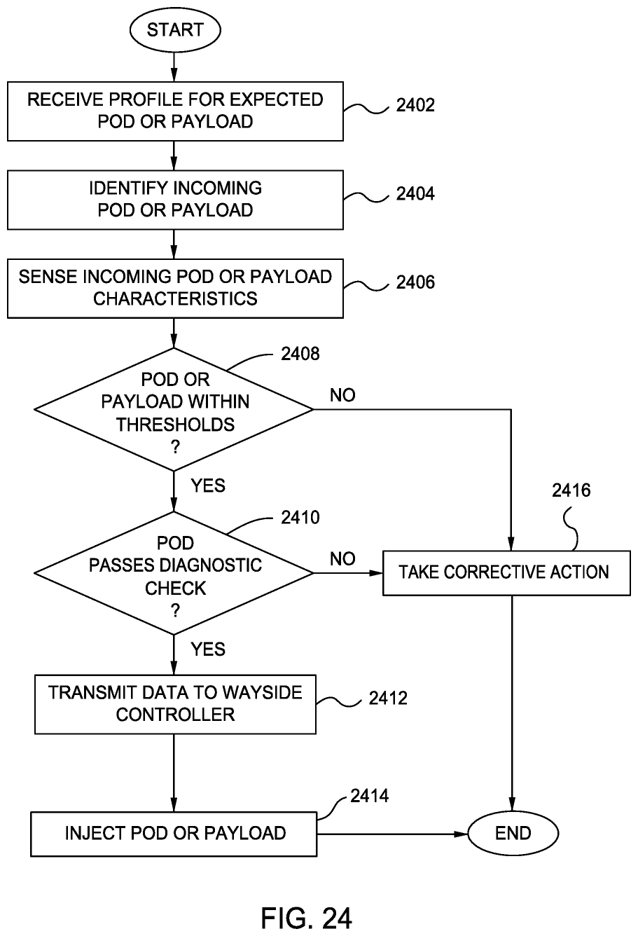

At block 2312, the pod control module injects the user into the system. In an embodiment, the pod control module performs any necessary pre-check, guides the user to a location to inject his or her pod or place the payload on a carrier pod, and then injects the user's pod or the carrier pod into the transportation system. Injecting a pod into the transportation system is discussed in more detail with regard to FIG. 24, below. In an embodiment, the pod control module transmits one or more commands to the wayside controller instructing the wayside controller to inject the pod, and including an acceleration target based on the profile for the pod (e.g., carrier and payload), and any passengers. In an embodiment, after the pod has been injected, the various wayside controllers by which it passes provide confirmation to the pod control module (or another suitable module) regarding the pod's progress through the transportation system.

FIG. 24 is a flowchart illustrating verifying a pod at a portal, according to one embodiment described herein. At block 2402, a pod control module for an injection portal (e.g., the pod control module 320b illustrated in FIG. 2) receives a user profile for an incoming pod or payload (e.g., as discussed above with regard to block 2308 in FIG. 23). At block 2402, the pod control module identifies the incoming pod or payload. In an embodiment, the pod control module identifies the incoming pod or payload using a license number or transponder identifier (e.g., by capturing an image of a license plate on a vehicle or scanning for a transponder identifier). Alternatively, the pod control module uses any other suitable information.

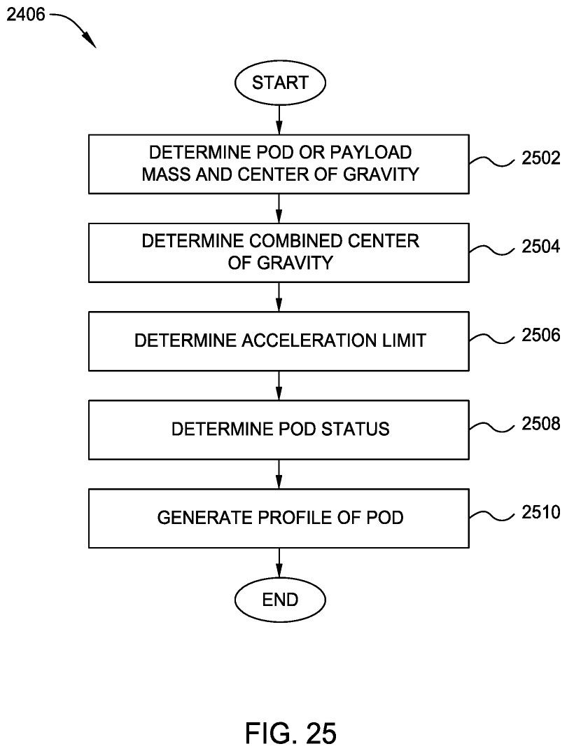

At block 2406, the pod control module senses the incoming pod or payload characteristics. This is discussed in more detail with regard to FIG. 25, below. At block 2408, the pod control module determines whether the pod or payload is within the required thresholds. In an embodiment, the pod control module uses a profile generated at block 2406 to make this determination (e.g., comparing measured mass, center of gravity, and surface profile with threshold values). In an embodiment, the threshold values are pre-set. Alternatively, the threshold values can be dynamically determined by the pod control module (or another suitable module) based on travel data and environmental characteristics (e.g., weather data).

If the pod's or payload's characteristics are not within the thresholds, the flow moves to block 2416 and the pod control module takes corrective action. In an embodiment, the corrective action includes an action for the pod, payload, or user to take to place the pod or payload in condition for use in the transportation system (e.g., closing windows or re-balancing a load). In an embodiment, the pod control module can provide instructions directly to the pod or payload (e.g., to lock the pod or payload, secure the cargo, or engage the brakes). In an embodiment, the pod control module can communicate with the pod or payload using a suitable communication standard (e.g., IEEE 802.11p).

Alternatively, audio and visual cues can be provided to the user to assist with the corrective action. For example, the pod control module can instruct the pod or payload to provide suitable instructions to the user (e.g., audio and visual cues to the user). Alternatively, the carrier, the portal, or a surrounding system can provide audio and visual cues. In an embodiment, the pod control module can direct the pod or payload to a temporary or holding area while the user performs the corrective action. This can allow other users to proceed through the portal.

In an alternative embodiment, the corrective action includes moving the pod or payload away from injection portal. In an embodiment, the pod control module determines that the pod or payload will not meet the thresholds prior to the pod or payload reaching the injection portal (e.g., because the expected mass, pod, payload, or passenger characteristics are not suitable for travel). In this embodiment, the pod control module can divert the pod or payload even before it reaches the injection portal, avoiding any traffic backup near the injection portal and saving time. This can be done directly with instructions to the pod or payload, or by providing instructions to a user to drive the pod or payload (e.g., audio or visual cues).

Alternatively, the pod control module determines that the pod or payload will not meet the thresholds while the pod or payload is in a pre-check or staging area (e.g., a precheck area discussed above with regard to FIGS. 18A-18E). In this embodiment, the pod control module diverts the pod or payload before it reaches the carrier. As another alternative, the pod control module determines that a payload will not meet the thresholds after the payload has been loaded on the carrier. In this embodiment, the pod control module can direct the payload off of the carrier (e.g., as discussed above with regard to FIGS. 18A-18E).

Returning to block 2408, if the pod control module determines that the pod or payload is within the threshold values, the flow proceeds to block 2410. At block 2410, the payload control module runs a diagnostic check on the pod (e.g., the user's pod or the carrier pod) and determines whether the pod passes the diagnostic check. For example, the pod control module (or another suitable module) runs a diagnostic check on the motor of the pod, any enclosure in the pod, any aerodynamic wings on the pod, etc. In an embodiment, the pod control module instructs the pod to perform the diagnostic check. If the pod control module determines that the pod does not pass the diagnostic check, the flow proceeds to block 2416 and the pod control module takes corrective action. This is discussed above.

If the pod control module determines that the pod passes the diagnostic check, the flow proceeds to block 2412. At block 2412, the pod control module transmits data for injecting the pod into the transportation to a wayside controller. For example. The pod control module can transmit center of gravity and mass information for the pod (e.g., the payload and carrier or the user's pod) to the wayside controller to assist in travel through the transportation system. In an embodiment, the pod control module is implemented as part of a wayside controller that does not control injection, and transmits data to a different wayside controller for injection. Alternatively, the pod control module is implemented as part of a wayside controller for the portal and controls injection, and this transmission is unnecessary.

At block 2414, the pod control module injects the pod or payload. As discussed above with regard to FIGS. 5-14, if the user requests travel using a carrier pod, in an embodiment the carrier includes one or more retention features to secure the payload to the carrier. In an embodiment, the pod control module moves the retention feature(s) to an appropriate position for securing the payload, senses the position of the payload (e.g., using a pressure sensor), and locks the retention feature(s). This secures the payload to the carrier.

In an embodiment, as discussed above, the pod includes an enclosure (e.g., an aerodynamic enclosure to assist in travel through the transportation system). If the pod includes an enclosure, at block 2414 the pod control module instructs the pod to secure the enclosure and any other necessary components. Alternatively, the pod does not include an enclosure. In an embodiment, the pod includes wheels or other suitable structure for traveling on traditional roads. In this embodiment, the pod control module instructs the pod to retract any wheels or other unnecessary structure for travel on in the high speed transportation system. Further, the pod control module can instruct the pod to extend any structures necessary for travel in the high speed transportation system (e.g., wings, motors, magnets, etc.). In an embodiment, a wayside controller associated with the portal then controls the pod to inject it into the high speed transportation system.

FIG. 25 is a flowchart illustrating sensing incoming pod or payload characteristics, according to one embodiment described herein. In an embodiment, this corresponds with block 2406 illustrated in FIG. 24. At block 2502, the pod control module determines the pod or payload mass and center of gravity. In an embodiment, the pod control module senses the mass of the incoming pod or payload using a scale, by measuring an amount of current (or another electrical parameter) used to levitate the pod (e.g., the user's pod or a carrier pod carrying the payload), or using any other suitable technique.

In an embodiment, the pod control module further senses the center of gravity of the pod or payload. For example, the pod control module can sense the center of gravity across three axes: (x, y, z). In an embodiment, the pod control module can determine the center of gravity across the x and y axes using a weight sensor under the wheels of the pod or payload. Alternatively, the pod control module can determine the center of gravity across the x and y axes based on the amount of current (or another electrical parameter) used to levitate the pod (e.g., the user's pod or a carrier pod after loading the payload). In an embodiment, a pod can include four motors located toward the corners of the pod, and the pod control module can measure the amount of current (or another electrical parameter) used to levitate each corner.

In an embodiment, the center of gravity across the z axis is measured by moving the pod or payload. For example, the pod control module can “jerk” the pod or payload a short distance and measure the pod or payload response to determine the center of gravity across the z axis. Further, this can detect any loose items or components in the pod or payload.

At block 2504, if the user is traveling using a carrier pod, the pod control module determines the combined center of gravity of the payload and carrier. In an embodiment, the pod control module loads the payload onto the carrier and measures the combined center of gravity, as discussed above. The pod control module can determine the combined center of gravity in addition to, or instead of, determining the center of gravity of the payload alone.

As discussed above, these techniques apply to a carrier pod with a payload and a pod suitable for travel on both traditional roads and in the high speed transportation system. These techniques can also apply to pods intended for travel on the guideway. In these circumstances, in an embodiment the pod control module determines the center of gravity along the x and y axes by measuring the weight or mass of each corner of the pod (e.g., using a scale or by measuring levitation current), and can measure the center of gravity along the z axis using a small “jerk” movement. In an embodiment, the acceptable center of gravity threshold can vary based on the type of pod. For example, a pod intended to carry standing passengers may have a different threshold than a pod intended to carry inanimate cargo.

At block 2506, the pod control module determines an acceleration limit associated with the pod. In an embodiment, this is based on the determined center of gravity. Further, this can be based on characteristics of the passengers in the user profile (discussed above). For example, a passenger may be elderly or may have health concerns that provide for a lower acceleration limit. Further, the acceleration limit can vary based on the type of payload and the type of pod. For example, a pod carrying only cargo may have a higher acceleration limit than a pod carrying seated passengers. As another example, a pod carrying seated passengers may have a higher acceleration limit than a pod expected to carry standing passengers (e.g., a carrier with a payload of a bus or shuttle, or a pod carrying standing passengers directly).

At block 2508, the pod control module determines the pod status. For example, in an embodiment, the pod control module determines whether all doors and windows in the pod or payload are closed. In an embodiment, the pod can include sensors to identify open doors and windows (e.g., visual sensors, infrared sensors, or other suitable sensors). Further, a carrier pod can include sensors to identify open doors and windows in a payload. Alternatively, a pre-check or staging area (e.g., as discussed in the Figures above) can include suitable sensors. As another alternative, a payload itself can include sensors to identify open doors or windows

Further, in an embodiment, the pod control module identifies the position of pod or the position of the payload in the carrier pod. For example, the pod control module can ensure that the pod is located in the proper position for injection, or ensure that the payload is located in the proper position and is anchored within the carrier pod. Further, the pod control module can verify that the brakes are engaged and that any cargo is secured in the payload and pod. The pod control module can do this with direct sensors, weight or mass sensors, visual sensors (e.g., a camera), or through other suitable techniques. These sensors can be located on the pod, in a pre-check or staging location, in the payload, or in any other suitable location.

At block 2510, the pod control module generates a profile of the pod. In an embodiment, this profile includes the mass, center of gravity, acceleration limit, and pod status information discussed above. Further, in an embodiment, the profile includes a two dimensional or three dimensional model of the pod's outer surface dimensions (e.g., including the payload, if applicable). This can be done using lasers, infra-red sensors, visual sensors (e.g., cameras) or using any other suitable tool. For example, a laser scanner could be used. Alternatively, one or more cameras could be used to capture images (e.g., from different perspectives) to generate a two dimensional or three dimensional model profile of the pod outer surface dimensions.

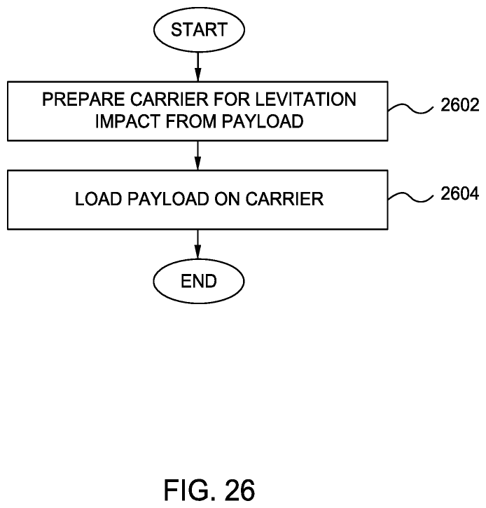

FIG. 26 is a flowchart further illustrating loading a payload onto a carrier, according to one embodiment described herein. At block 2602, a pod control module (e.g., the pod control module 320a or 320b illustrated in FIG. 2) prepares the carrier for any levitation impact from the payload. As discussed above, in an embodiment the carrier uses magnetic levitation to travel through the transportation system. In an embodiment, the carrier is levitating before the payload is loaded onto the carrier. In this embodiment, the pod control module determines the additional mass that will be added to the carrier when the payload is loaded on, and prepares the carrier for this sudden addition of mass. In an embodiment, the measured mass discussed above with regard to block 2502 in FIG. 25 can be used by the pod control module to prepare for loading the payload into the carrier. As another alternative, the pod control can provide the maximum available levitation force to the carrier, so that adding the payload has minimal impact on levitation.

Alternatively, the carrier can be attached to a secure surface (e.g., the ground or a side rail of the portal) to provide support for adding the payload. In this embodiment, the carrier can be fully, or partially, resting on the support surface (e.g., the ground or a rail), so that the carrier will not be impacted by the sudden addition of the payload. In this embodiment, the pod control system can initiate magnetic levitation in the carrier after the payload has been added.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the claims except where explicitly recited in a claim(s). Likewise, reference to “the invention” or “the disclosure” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system.”

Embodiment of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof.

1. A method for injecting a vehicle into a transportation system, the method comprising:
receiving a travel request from a user for the transportation system;
determining that the user is authorized to travel using the transportation system, based on a profile associated with the user;
identifying an injection portal for the user to enter the transportation system;
providing one or more instructions for the user relating to the injection portal;
transmitting a notification to a first controller associated with the injection portal, the notification comprising identification data related to the user;
identifying, at the injection portal, a vehicle associated with the user, based on the identification data;
sensing a plurality of characteristics of the vehicle at the injection portal, the plurality of characteristics comprising a center of gravity of the vehicle;
determining that the plurality of characteristics satisfy one or more corresponding threshold values, and based on this determination authorizing the vehicle for travel in the transportation system;
generating a vehicle profile related to the vehicle;
transmitting, using a communication network, the vehicle profile to a second controller associated with the transportation system; and
injecting the vehicle into the transportation system, at the injection portal.

2. The method of claim 1, further comprising:
identifying a carrier pod for the transportation system;
securing the vehicle to the carrier pod as a payload; and
injecting the carrier pod into the transportation system, at the injection portal.

3. The method of claim 1, further comprising:
identifying, at the injection portal, a second vehicle;
sensing a second plurality of characteristics associated with the second vehicle; and
determining that the second plurality of characteristics do not satisfy a second corresponding one or more threshold values, and in response instructing a second user associated with the second vehicle to take corrective action.

4. The method of claim 3, wherein the corrective action comprises an instruction to exit the injection portal.

5. The method of claim 1, wherein sensing the plurality of characteristics of the vehicle further comprises:
measuring a center of gravity of the vehicle in a first axis using one or more sensors;
measuring a center of gravity of the vehicle in a second axis using one or more sensors; and
measuring a center of gravity of the vehicle in a third axis based on a movement of the vehicle.

6. The method of claim 1, wherein sensing the plurality of characteristics of the vehicle further comprises:
measuring a mass of the vehicle using an electrical parameter related to magnetic levitation for the vehicle.

7. The method of claim 1,
wherein sensing a plurality of characteristics of the vehicle further comprises generating a three dimensional model of the vehicle using one or more sensors, and
wherein determining that the plurality of characteristics satisfy one or more corresponding threshold values further comprises determining, based on the three dimensional model, that the vehicle satisfies a threshold value relating to outer dimensions of the vehicle.

8. A method for injecting a vehicle into a transportation system, the method comprising:
identifying an injection portal for a user to enter the transportation system;
identifying, at the injection portal, a vehicle associated with the user;
sensing a plurality of characteristics of the vehicle at the injection portal;
determining that the plurality of characteristics satisfy one or more corresponding threshold values and, based on this determination authorizing the vehicle for travel in the transportation system; and
injecting the vehicle into the transportation system, at the injection portal.

9. The method of claim 8, further comprising:
identifying a carrier pod for the transportation system;
securing the vehicle to the carrier pod as a payload; and
injecting the carrier pod into the transportation system, at the injection portal.

10. The method of claim 8, further comprising:
identifying, at the injection portal, a second vehicle;
sensing a second plurality of characteristics associated with the second vehicle; and
determining that the second plurality of characteristics do not satisfy a second corresponding one or more threshold values, and in response instructing a second user associated with the second vehicle to take corrective action.

11. The method of claim 8, wherein sensing the plurality of characteristics of the vehicle further comprises:
measuring a center of gravity of the vehicle in a first axis using one or more sensors;
measuring a center of gravity of the vehicle in a second axis using one or more sensors; and
measuring a center of gravity of the vehicle in a third axis based on a movement of the vehicle.

12. The method of claim 8, wherein sensing the plurality of characteristics of the vehicle further comprises:
measuring a mass of the vehicle using an electrical parameter related to magnetic levitation for the vehicle.

13. The method of claim 8,
wherein sensing a plurality of characteristics of the vehicle further comprises generating a three dimensional model of the vehicle using one or more sensors, and
wherein determining that the plurality of characteristics satisfy one or more corresponding threshold values further comprises determining, based on the three dimensional model, that the vehicle satisfies a threshold value relating to outer dimensions of the vehicle.

14. The method of claim 8, wherein identifying an injection portal for the user to enter the transportation system further comprises:
identifying a location of the vehicle associated with the user; and
determining the injection portal based on the location.

15. A method for injecting a vehicle into a transportation system, the method comprising:
identifying, at an injection portal associated with the transportation system, a vehicle associated with a user;
sensing a plurality of characteristics of the vehicle at the injection portal, the plurality of characteristics comprising a center of gravity of the vehicle;
determining that the plurality of characteristics satisfy one or more corresponding threshold values, and based on this determination authorizing the vehicle for travel in the transportation system; and
injecting the vehicle into the transportation system, at the injection portal.

16. The method of claim 15, further comprising:
identifying a carrier pod for the transportation system;
securing the vehicle to the carrier pod as a payload; and
injecting the carrier pod into the transportation system, at the injection portal.

17. The method of claim 15, further comprising:
identifying, at the injection portal, a second vehicle;
sensing a second plurality of characteristics associated with the second vehicle; and
determining that the second plurality of characteristics do not satisfy a second corresponding one or more threshold values, and in response instructing a second user associated with the second vehicle to take corrective action.

18. The method of claim 15, wherein sensing the plurality of characteristics of the vehicle further comprises:
measuring a center of gravity of the vehicle in a first axis using one or more sensors;
measuring a center of gravity of the vehicle in a second axis using one or more sensors; and
measuring a center of gravity of the vehicle in a third axis based on a movement of the vehicle.

19. The method of claim 15, wherein sensing the plurality of characteristics of the vehicle further comprises:
measuring a mass of the vehicle using an electrical parameter related to magnetic levitation for the vehicle.

20. The method of claim 15,
wherein sensing a plurality of characteristics of the vehicle further comprises generating a three dimensional model of the vehicle using one or more sensors, and wherein determining that the plurality of characteristics satisfy one or more corresponding threshold values further comprises determining, based on the three dimensional model, that the vehicle satisfies a threshold value relating to outer dimensions of the vehicle.
